(19) United States
(12) Patent Application Publication
(10) Pub. No.: US 2016/0360559 A1
(43) Pub. Date: Dec. 8, 2016

(54) COEXISTENCE AMONG WIRELESS DEVICES USING PEER-TO-PEER SIGNALING

(71) Applicant: QUALCOMM Incorporated, San Diego, CA (US)

(72) Inventors: George CHRISIKOS, San Diego, CA (US); Richard Dominic WIETFELDT, San Diego, CA (US)

(21) Appl. No.: 15/167,393

(22) Filed: May 27, 2016

Related U.S. Application Data
(60) Provisional application No. 62/170,020, filed on Jun. 2, 2015.
(60) Provisional application No. 62/235,196, filed on Sep. 30, 2015.

(51) Int. Cl. H04W 76/02; H04W 48/16; H04W 8/00; H04L 12/26

(52) U.S. Cl. CPC H04W 76/02; H04L 43/16; H04W 48/16; H04W 8/005

(57) ABSTRACT

Systems and methods are disclosed for improving coexistence among wireless devices. A method may include detecting interference on a first radio access technology (RAT) channel, initiating a discovery protocol to identify a proximate wireless device in response to the detecting, establishing a wireless communication connection with the proximate wireless device, requesting radio configuration information and radio change capability information from the proximate wireless device, receiving the radio configuration information and the radio change capability information, and attempting to mitigate interference based on the radio configuration information and the radio change capability information received from the proximate wireless device.

### CROSS-REFERENCE TO RELATED APPLICATIONS

The present application for patent claims the benefit of U.S. Provisional Application No. 62/170,020, entitled “IMPROVING COEXISTENCE AMONG WIRELESS DEVICES USING PEER-TO-PEER SIGNALING,” filed Jun. 2, 2015, and U.S. Provisional Application No. 62/235,196, entitled “IMPROVING COEXISTENCE AMONG WIRELESS DEVICES USING PEER-TO-PEER SIGNALING,” filed Sep. 30, 2015, each assigned to the assignee hereof, and each expressly incorporated herein by reference in its entirety.

### INTRODUCTION

Aspects of this disclosure relate generally to improving coexistence among wireless devices, and more particularly to systems and methods for attempting to mitigate interference among devices based on radio configuration information and radio change capability information.

Wireless communication systems have developed through various generations, including a first-generation (1G) analog wireless phone service, a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies. More recently, Long-Term Evolution (LTE) has been developed as a wireless communication protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

Access networks using various communication protocols (e.g., 3GPP access networks such as W-CDMA, LTE, etc., or non-3GPP access networks such as WiFi, WLAN or wired LAN, etc.) can be configured to provide Internet Protocol (IP) Multimedia Subsystem (IMS) services via an IMS network managed by an operator (e.g., Verizon, Sprint, AT&T, etc.) to users across a communication system. Users that access the IMS network to request an IMS service are assigned to one of a plurality of regional application servers or application server clusters (e.g., groups of application servers that serve the same cluster region) for supporting the requested IMS service.

Wireless devices may be equipped with multiple radios for communicating using different radio access technologies (RATs). A particular issue arises in the case of cross-device interference. As will be described in more detail below, experiments have shown that a first wireless device can experience interference due to the operations of a proximate wireless device, even if the respective wireless devices are operating on different frequencies using different RATs. The impact and likelihood of cross-device interference may increase as the number of wireless devices in a given area increases, or as the distance between wireless devices decreases. Moreover, a cross-device interference scenario may include multiple victim devices and/or multiple aggressor devices. Accordingly, solutions are needed for mitigating cross-device interference caused by proximate wireless devices.

### SUMMARY

The following summary is an overview provided solely to aid in the description of various aspects of the disclosure and is provided solely for illustration of the aspects and not limitation thereof.

In one aspect, the present disclosure provides a method for improving coexistence among wireless devices. The method may comprise, for example, detecting, at a first wireless device, interference to a first radio access technology (RAT) communication connection established by the first wireless device, initiating, by the first wireless device, a discovery protocol to identify a proximate wireless device in response to the detecting, establishing, by the first wireless device, a wireless communication connection with the proximate wireless device, requesting, by the first wireless device, radio configuration information and radio change capability information from the proximate wireless device via the wireless communication connection, receiving, at the first wireless device, the radio configuration information and radio change capability information from the proximate wireless device via the wireless communication connection, attempting, by the first wireless device, to mitigate interference between the first wireless device and the proximate wireless device based on the radio configuration and radio change capability information received from the interfering wireless device.

In another aspect, the present disclosure provides an apparatus for improving coexistence among wireless devices. The apparatus may comprise, for example, a plurality of transceivers, each of the plurality of transceivers configured to establish a communication connection; and a coexistence manager configured to detect interference to a first radio access technology (RAT) communication connection established by at least one of the plurality of transceivers, initiate a discovery protocol to identify a proximate wireless device in response to the detecting, establish, via at least one of the plurality of transceivers, a wireless communication connection with the proximate wireless device, request, via the at least one of the plurality of transceivers, radio configuration information and radio change capability information from the proximate wireless device, receive, via the at least one of the plurality of transceivers, the radio configuration information and radio change capability information from the proximate wireless device via the wireless communication connection, and attempt to mitigate interference based on the radio configuration and radio change capability information received from the interfering wireless device.

In yet another aspect, the present disclosure provides another apparatus for improving coexistence among wireless devices. The apparatus may comprise, for example, means for detecting interference to a first radio access technology (RAT) communication connection established by the first wireless device, means for initiating a discovery protocol to identify a proximate wireless device in response to the detecting, means for establishing a wireless communication connection with the proximate wireless device, means for requesting radio configuration information and radio change capability information from the proximate wireless device via the wireless communication connection, means for receiving the radio configuration information and radio change capability information from the proximate wireless device via the wireless communication connection, and means for attempting to mitigate interference based on the radio configuration and radio change capability information received from the interfering wireless device.

In yet another aspect, the present disclosure provides a non-transitory computer-readable medium comprising code, which, when executed by a processor, causes the processor to perform operations for improving coexistence among wireless devices, the non-transitory computer-readable medium comprising code for detecting interference to a first radio access technology (RAT) communication connection established by the first wireless device, code for initiating a discovery protocol to identify a proximate wireless device in response to the detecting, code for establishing a wireless communication connection with the proximate wireless device, code for requesting radio configuration information and radio change capability information from the proximate wireless device via the wireless communication connection, code for receiving the radio configuration information and radio change capability information from the proximate wireless device via the wireless communication connection, and code for attempting to mitigate interference based on the radio configuration and radio change capability information received from the interfering wireless device.

In yet another aspect, the present disclosure provides another method for improving coexistence among wireless devices. The method may comprise, for example, discovering, by a first wireless device, a proximate wireless device, establishing, by the first wireless device, a wireless communication connection with the proximate wireless device, receiving, from the proximate wireless device via the wireless communication connection, a request for radio configuration information and radio change capability information determining, by the first wireless device, radio configuration information and radio change capability information relating to radio operations of the first wireless device, and transmitting the radio configuration information and radio change capability information to the proximate wireless device.

In yet another aspect, the present disclosure provides another apparatus for improving coexistence among wireless devices. The apparatus may comprise, for example, a plurality of transceivers associated with a first wireless device, each of the plurality of transceivers configured to establish a communication connection, a coexistence manager configured to discover a proximate wireless device, establish a wireless communication connection with the proximate wireless device, receive, from the proximate wireless device via the wireless communication connection, a request for radio configuration information and radio change capability information, determine radio configuration information and radio change capability information relating to radio operations of the first wireless device, and transmit the radio configuration information and radio change capability information to the proximate wireless device.

In yet another aspect, the present disclosure provides another apparatus for improving coexistence among wireless devices. The apparatus may comprise, for example, means for discovering a proximate wireless device, means for establishing a wireless communication connection with the proximate wireless device, means for receiving, from the proximate wireless device via the wireless communication connection, a request for radio configuration information and radio change capability information, means for determining radio configuration information and radio change capability information relating to radio operations of the first wireless device, and means for transmitting the radio configuration information and radio change capability information to the proximate wireless device.

In yet another aspect, the present disclosure provides another non-transitory computer-readable medium comprising code, which, when executed by a processor, causes the processor to perform operations for improving coexistence among wireless devices. The non-transitory computer-readable medium may comprise, for example, means for discovering a proximate wireless device, means for establishing a wireless communication connection with the proximate wireless device, means for receiving, from the proximate wireless device via the wireless communication connection, a request for radio configuration information and radio change capability information, means for determining radio configuration information and radio change capability information relating to radio operations of the first wireless device, and means for transmitting the radio configuration information and radio change capability information to the proximate wireless device.

In yet another example, a communication apparatus is disclosed. The communication apparatus may include, for example, one or more transceivers configured to detect, at a wireless device, interference in a communication medium, establish a wireless device-to-device (D2D) communication connection with two or more discovered devices, receive cross-device coexistence management (XDCxM) data via the wireless D2D communication connection, wherein the XDCxM data includes a radio configuration report from at least one of the two or more discovered devices, and transmit a selected radio change request to an aggressor device via the wireless D2D communication connection, and a processor configured to identify the aggressor device from among the two or more discovered devices based on the radio configuration report, and select the radio change request for the aggressor device, and memory coupled to the processor and configured to store data, instructions, or a combination thereof.

In yet another example, a communication method for improving coexistence is disclosed. The communication method for improving coexistence may include, for example, detecting, at a wireless device, interference in a communication medium, establishing a wireless device-to-device (D2D) communication connection with two or more discovered devices, receiving cross-device coexistence management (XDCxM) data via the wireless D2D communication connection, wherein the XDCxM data includes a radio configuration report from at least one of the two or more discovered devices, identifying an aggressor device from among the two or more discovered devices based on the radio configuration report, selecting a radio change request for the aggressor device, and transmitting the radio change request to the aggressor device via the wireless D2D communication connection.

In yet another example, a communication apparatus for improving coexistence is disclosed. The communication apparatus for improving coexistence may include, for example, one or more transceivers configured to establish, from a wireless device, a wireless device-to-device (D2D) communication connection with two or more discovered devices, transmit cross-device coexistence management (XDCxM) data via the wireless D2D communication connection, the XDCxM data including a radio configuration report based on a configuration of one or more parameters of one or more radios associated with the wireless device receive, via the wireless D2D communication connection, a first radio change request from a first wireless device of the two or more discovered devices, and receive, via the wireless D2D communication connection, a second radio change request from a second wireless device of the two or more discovered devices, a processor configured to select a preferred radio change request from among the first radio change request and the second radio change request, and change one or more of the one or more radio parameters based on the preferred radio change request, and memory coupled to the processor and configured to store data, instructions, or a combination thereof.

In yet another example, a communication method for improving coexistence is disclosed. The communication method for improving coexistence may include, for example, establishing, from a wireless device, a wireless device-to-device (D2D) communication connection with two or more discovered devices, transmitting cross-device coexistence management (XDCxM) data via the wireless D2D communication connection, the XDCxM data including a radio configuration report based on a configuration of one or more parameters of one or more radios associated with the wireless device, and receiving, via the wireless D2D communication connection a first radio change request from a first wireless device of the two or more discovered devices, and a second radio change request from a second wireless device of the two or more discovered devices, selecting a preferred radio change request from among the first radio change request and the second radio change request, and changing one or more of the one or more radio parameters based on the preferred radio change request.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 generally illustrates a conventional wireless environment in which a first wireless device experiences cross-device interference.

FIG. 2A illustrates example in-device coexistence impacts that may occur in the wireless environment shown in FIG. 1, according to various aspects.

FIG. 2B illustrates example cross-device coexistence impacts that may occur in the wireless environment shown in FIG. 1, according to various aspects.

FIG. 3A generally illustrates a wireless environment in which wireless devices use a coexistence protocol to mitigate cross-device interference in accordance with an aspect of the disclosure.

FIG. 3B generally illustrates another wireless environment in which wireless devices use a coexistence protocol to mitigate cross-device interference in accordance with an aspect of the disclosure.

FIG. 4 generally illustrates examples of wireless devices in accordance with aspects of the disclosure.

FIG. 5 generally illustrates a communications device that includes structural components in accordance with an embodiment of the disclosure.

FIG. 6 generally illustrates a flow diagram of a method for improving coexistence between two wireless devices in accordance with an aspect of the disclosure.

FIG. 7 generally illustrates a flow diagram of a method for coexistence management service authorization in accordance with another aspect of the disclosure.

FIG. 8 generally illustrates a flow diagram of a method for coexistence management service discovery in accordance with another aspect of the disclosure.

FIG. 9 generally illustrates a flow diagram of a method for coexistence management control operation in accordance with another aspect of the disclosure.

FIG. 10 generally illustrates a flow diagram method for improving coexistence among three or more wireless devices.

FIG. 11 generally illustrates in more detail an example implementation of certain aspects of the method of FIG. 10.

FIG. 12 generally illustrates in more detail another example implementation of certain aspects of the method of FIG. 10.

FIG. 13 generally illustrates in more detail yet another example implementation of certain aspects of the method of FIG. 10.

FIG. 14 generally illustrates another flow diagram method for improving coexistence among three or more wireless devices.

### DETAILED DESCRIPTION

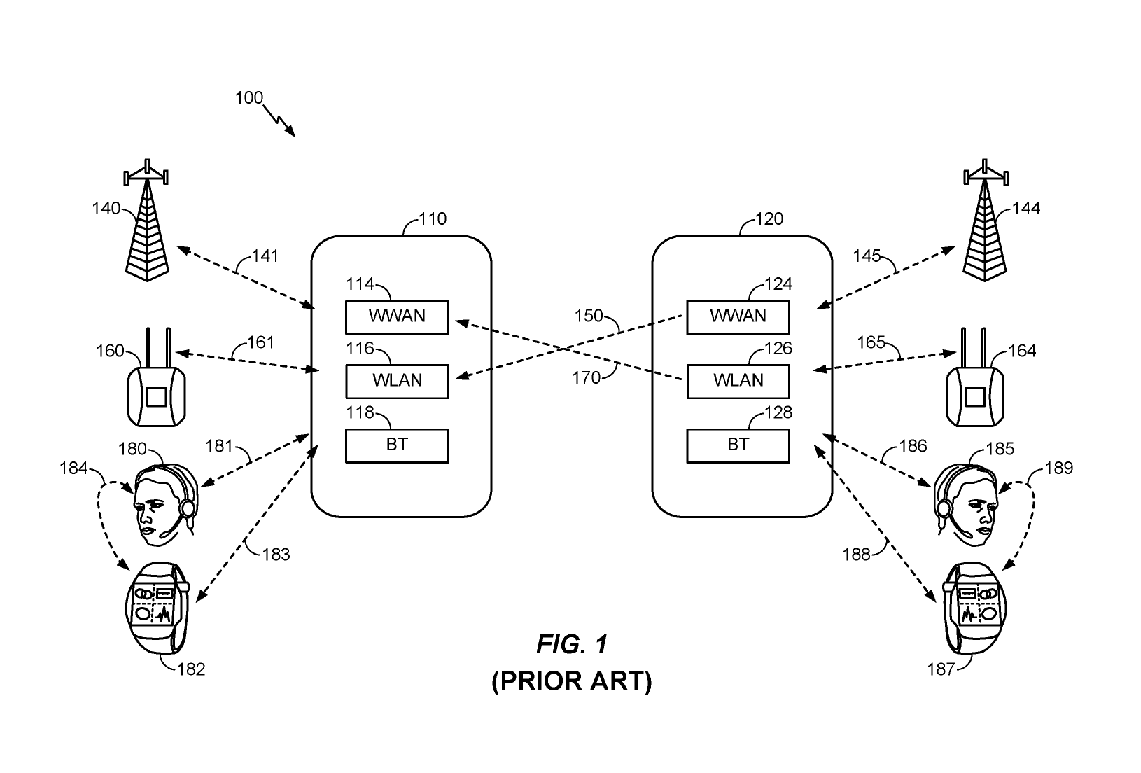

FIG. 1 generally illustrates an example of a coexistence issue that may arise in a wireless environment 100 when wireless devices are in proximity to one another. The wireless environment 100 may comprise a communication medium through which wireless communication links can be established. A first wireless device 110 includes multiple radios, each radio operating in accordance with a different radio access technology (RAT). The first wireless device 110 includes a first wireless wide area network (WWAN) radio 114, a first wireless local area network (WLAN) radio 116, and a first Bluetooth radio 118. The first wireless device 110 can use the radios 114, 116, 118 to communicate within the wireless environment 100. For example, as depicted in FIG. 1, the first wireless device 110 can wirelessly communicate with a base station 140 over a WWAN link 141 using the WWAN radio 114. The first wireless device 110 can also wirelessly communicate with an access point 160 over a WLAN link 161 using the WLAN radio 116. Finally, the first wireless device 110 can wirelessly communicate with Bluetooth devices 180, 182 over Bluetooth links 181, 183 using the Bluetooth radio 118. The Bluetooth devices 180, 182 may further be wirelessly communicating with each other over a Bluetooth link 184.

The wireless environment 100 may also include a second wireless device 120. Like the first wireless device 110, the second wireless device 120 includes multiple radios, each radio operating in accordance with a different RAT. The second wireless device 120 includes a second WWAN radio 124, a second WLAN radio 126, and a second Bluetooth radio 128. The second wireless device 120 can use the radios 124, 126, 128 to communicate within the wireless environment 100. For example, as depicted in FIG. 1, the second wireless device 120 can wirelessly communicate with a base station 144 over a WWAN link 145 using the WWAN radio 124. The second wireless device 120 can also wirelessly communicate with an access point 164 over a WLAN link 165 using the WLAN radio 126. Finally, the second wireless device 120 can wirelessly communicate with Bluetooth devices 185, 187 over Bluetooth links 186, 188 using the Bluetooth radio 128. The Bluetooth devices 185, 187 may further be wirelessly communicating with each other over a Bluetooth link 189.

Although the base station 140 and base station 144 are depicted as separate and distinct, it will be understood that the wireless devices 110, 120 may in fact be in communication with the same base station, rather than separate and distinct base stations. In other words the WWAN links 141, 145 may have a common endpoint. Analogously, access points 160, 164 may be a single access point rather than separate and distinct access points, as shown in FIG. 1.

Regardless of the particular arrangement, the various links between each of the wireless devices 110, 120 and the wireless environment 100 may interfere with the operations of the other wireless device. In many wireless environments, various techniques are used to mitigate interference. For example, a base station that is shared by the first wireless device 110 and the second wireless device 120 may be designed to mitigate interference between the operations of the WWAN radio 114 and the WWAN radio 124.

However, a particular issue arises in the case of cross-device interference. As will be described in more detail below, experiments and analysis have shown that a first wireless device may experience interference due to the operations of a second wireless device, even if the first wireless device is operating on a different frequency and/or using a different RAT. In FIG. 1, for example, the second wireless device 120 operates using the WWAN radio 124 to communicate with base station 144 via WWAN link 145. However, the WWAN operations of the second wireless device 120 may interfere with WLAN operations of the first wireless device 110. This cross-device interference is shown in FIG. 1 as an interference signal 150. Additionally or alternatively, WLAN operation of the second wireless device 120 may interfere with WWAN operation of the first wireless device 110. This cross-device interference is shown in FIG. 1 as an interference signal 170. Although FIG. 1 only depicts the interference signal 150 and the interference signal 170, it will be understood that under some circumstances, the operations of any of the radios 114, 116, 118, 124, 126, 128 may result in cross-device interference with any of the other radios. The impact and likelihood of cross-device interference may increase as the number of wireless devices in a given area increases and the distance between wireless devices decreases. Other factors include antenna isolation between victim and aggressor radios, for example, placements of obstructions, channel propagation, etc. Accordingly, solutions are needed for mitigating cross-device interference.

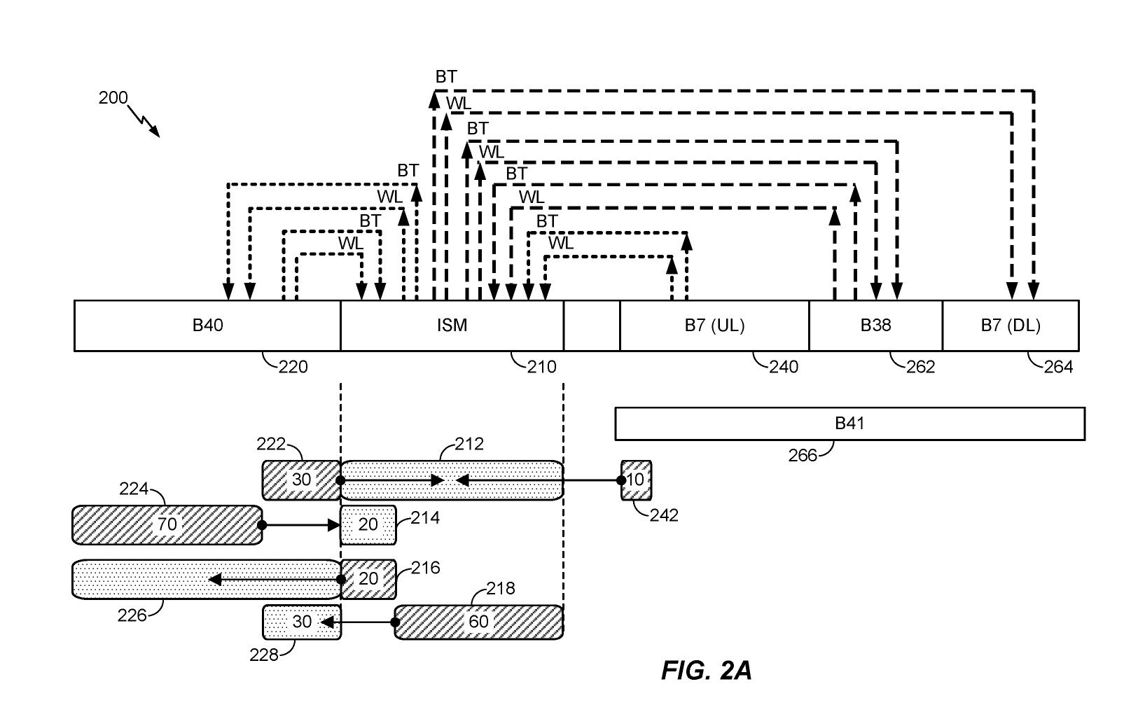

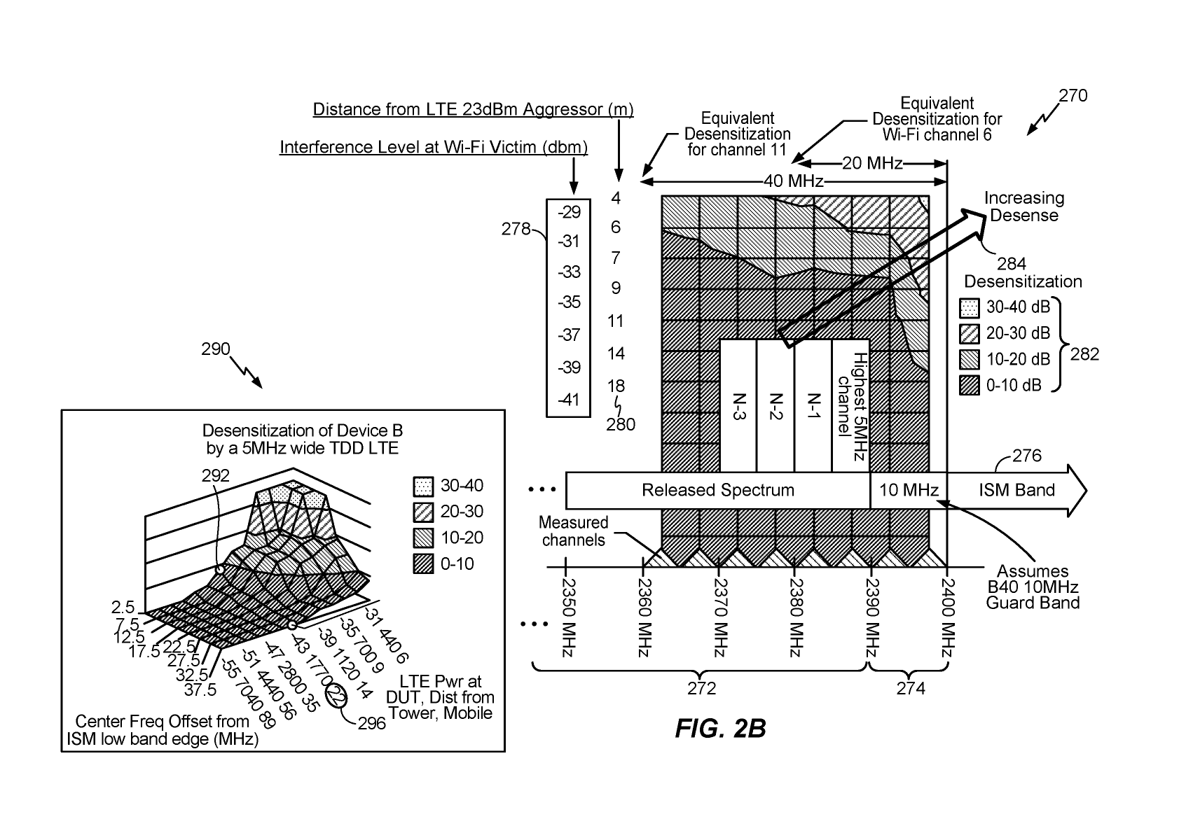

For example, FIG. 2A illustrates various examples relating to the possible in-device coexistence impacts that may occur in the wireless environment 100. More particularly, FIG. 2A shows an example frequency spectrum portion 200 that comprises several radio bands, including the industrial, scientific and medical (ISM) band 210. In that context, the example in-device coexistence impacts shown in FIG. 2A may apply to a particular situation in which coupling and/or isolation between antennas on a particular wireless device is the culprit that causes the in-device coexistence impacts. Furthermore, the various in-device coexistence impacts and regions in the frequency spectrum portion 200 shown in FIG. 2A apply to a particular scenario, and as such, may vary from one device to another depending on distance, filtering, device architectures, and/or other factors, as would be apparent to those skilled in the art.

As depicted in FIG. 2A, the ISM band 210 has an 83 MHz bandwidth and covers frequencies ranging from 2400 MHz to 2483 MHz, wherein the ISM band 210 may commonly be positioned between other neighboring radio bands used to operate in accordance with 3rd Generation Partnership Project (3GPP) specifications. For example, as shown in FIG. 2A, the 3GPP operating band 40 (hereinafter the “B40 band”) 220 uses time-division duplexing (TDD) to operate on frequencies that range from 2300 MHz to 2400 MHz. Furthermore, as shown in FIG. 2A, the 3GPP operating band 7 includes an uplink (UL) portion 240 (hereinafter the “B7 UL band”) that uses frequency-division duplexing (FDD) to operate on frequencies ranging from 2500 MHz to 2570 MHz and a downlink (DL) portion 264 (hereinafter the “B7 DL band”) that uses FDD to operate on frequencies ranging from 2620 MHz to 2690 MHz. In addition, between the B7 UL band 240 and the B7 DL band 264, the 3GPP operating band 38 (hereinafter the “B38 band”) 262 uses TDD to operate on frequencies ranging from 2570 MHz to 2620 MHz, while the 3GPP operating band 41 (hereinafter the “B41 band”) 266 uses TDD to operate on frequencies ranging from 2496 MHz to 2690 MHz. However, those skilled in the art will appreciate that the frequencies shown in FIG. 2A (and described herein) are approximations.

Accordingly, as shown in FIG. 2A, the ISM band 210 is proximate to the B40 band 220, whereby there may be little to no guard band between the ISM band 210 and the B40 band 220. Furthermore, the ISM band 210 is also proximate to the B7 UL band 240 and the B41 band 266, and the ISM band 210 is less proximate to the B38 band 262 and the B7 DL band 264. However, as will be discussed in further detail below, operations in any of the various bands 210, 220, 240, 262, 264, 266 in the frequency spectrum portion 200 shown in FIG. 2A can potentially interfere with operations in one or more other bands in the illustrated frequency spectrum portion 200. As such, those skilled in the art will appreciate that FIG. 2A merely provides exemplary interference (or coexistence) issues that can arise in the frequency spectrum portion 200 shown therein. Moreover, those skilled in the art will appreciate that FIG. 2A may not provide a complete picture with respect to the potential interference (or coexistence) issues that may occur in the depicted frequency spectrum portion 200 and further that operations outside the depicted frequency spectrum portion 200 can further cause potential interference or coexistence issues with respect to operations that are within the depicted frequency spectrum portion 200 (and vice-versa). Accordingly, in-device and/or cross-device coexistence issues may arise across different RATs in any portion of the frequency spectrum, and the solutions described herein to select an appropriate device-to-device (D2D) RAT in a manner that may mitigate such in-device and/or cross-device coexistence issues are generally applicable anywhere that the RAT used in a D2D connection may cause in-device and/or cross-device coexistence issues.

As noted above, FIG. 2A illustrates various example in-device coexistence impacts that may occur when wireless devices establish a D2D connection using one or more RATs that operate in the illustrated frequency spectrum portion 200, wherein the examples shown in FIG. 2A may generally comprise in-device coexistence impacts between operations within the ISM band 210 and LTE operations outside the ISM band 210. However, as further mentioned above, the example in-device coexistence impacts and regions in the frequency spectrum portion 200 shown in FIG. 2A apply to a particular scenario, and as such, may vary from one device to another depending on distance, filtering, device architectures, and/or other factors. For example, the desensing depicted in FIG. 2A at 212, 214, 226, 228, etc. represents best-case results with a high-performance thin-film bulk acoustic resonator (FBAR) filter. Accordingly, in a device that uses a more typical and relatively cheaper surface acoustic wave (SAW) filter, entire portions of bands may be rendered inoperable, including the operations shown at 222, 242, 224, 216, 218 in addition to the desensing depicted at 212, 214, 226, 228 where high-performance FBAR filters are used. Furthermore, although the results shown in FIG. 2A represent example in-device coexistence impacts where the various RATs are designed for coexistence such that high-performance filters are used, the results could be much worse when encountering a cross-device victim/aggressor scenario where higher cost filters were not used in anticipation of possible coexistence problems. Further still, the results shown in FIG. 2A may depend on transmit power, receiver sensitivity, etc., and filters may also have performance variations due to temperature and process variation, further complicating coexistence mitigation efforts. As such, those skilled in the art will appreciate that any particular values referred to herein and any particular in-device and/or cross-device coexistence impacts described herein are merely illustrative with respect to the particular scenarios depicted and described, as there will be many different factors that can cause in-device and/or cross-device coexistence impacts between two wireless devices seeking to establish a D2D connection.

For example, in the particular scenario shown in FIG. 2A, LTE operations 242 that are conducted in the B7 UL band 240 and use the closest channel to the ISM band 210 (e.g., the lowest 10 MHz in the B7 UL band) can cause in-device coexistence impacts whereby Bluetooth and/or WLAN operations may be desensed across the ISM band 210, as depicted at 212 (e.g., the LTE operations 242 in the B7 UL band 240 may desense WLAN channel 11 by ˜30 decibels (dB), wherein the densensing shown at 212 can be more or less than 30 dB depending on circumstances). In another example, LTE operations that use the top 30 MHz in the B40 band 220, as depicted at 222, can cause in-device coexistence impacts whereby Bluetooth and/or WLAN operations may be desensed across the ISM band 210, as further depicted at 212. However, LTE operations in the bottom 70 MHz in the B40 band 220, as depicted at 224, may cause a smaller in-device coexistence impact, whereby desensing may only be experienced in the lower 20 MHz in the ISM band 210, as depicted at 214. Furthermore, Bluetooth and/or WLAN operations within the ISM band 210 can cause coexistence impacts outside the ISM band 210. For example, Bluetooth and/or WLAN operations that use the lower 20 MHz in the ISM band 210, as depicted at 216, can cause an in-device coexistence impact in that LTE operations may be desensed across the entire B40 band 220, as depicted at 226. However, Bluetooth and/or WLAN operations conducted above ˜2420 MHz, as depicted at 218, may cause a relatively smaller in-device coexistence impact, whereby desensing may only be experienced in the upper 30 MHz in the B40 band 220, as depicted at 228. Again, as mentioned above, those skilled in the art will appreciate that the in-device coexistence impacts shown in FIG. 2A and the degree to which such in-device coexistence impacts may cause desensing due to operations in different RATs may vary based on many factors, which may include filter parameters, transmit power, and receiver sensitivity levels, among many other factors.

Furthermore, FIG. 2B illustrates example cross-device coexistence impacts. More particularly, the graph depicted at 270 may generally illustrate cross-device coexistence impacts where LTE operations that a first wireless device (e.g., wireless device 110) conducts in a released spectrum portion 272 within the B40 band may cause interference and/or desensing at a second wireless device (e.g., wireless device 120) conducting WiFi operations in the ISM band 276, wherein the example shown at 270 may assume a 10 MHz guard band 274 between the ISM band 276 and the released spectrum portion 272 in the B40 band, wherein the released spectrum portion 272 may typically extend all the way down to 2300 MHz and all the way up to 2400 MHz (e.g., without the guard band 274). Accordingly, in the illustrated example that assumes the 10 MHz guard band 274 between the ISM band 276 and the released spectrum portion 272 in the B40 band, the first wireless device may conduct the LTE operations in the released spectrum portion 272 in the B40 band between ˜2300 MHz to 2390 MHz. Furthermore, in the example illustrated in FIG. 2B, the measured channels in the B40 band generally range from ˜2360 MHz to ˜2400 MHz because experimental results and analysis did not reveal significant problems in the lower channels in the B40 band, as can be extrapolated from the cross-device coexistence impacts shown in FIG. 2B. Accordingly, in the following description, the first wireless device conducting the LTE operations in the released spectrum portion 272 within the B40 band may be referred to as an “LTE 23 dBm aggressor” and the second wireless device that conducts the WiFi operations in the ISM band 276 and may experience potential interference/desensing cross-device coexistence impacts from the LTE 23 dBm aggressor may be referred to as a “WiFi victim.”

As shown in the graph depicted at 270, an interference level 278 that the WiFi victim experiences due to the operations that the LTE 23 dBm aggressor conducts on any particular channel within the depicted released spectrum portion 272 within the B40 band may vary depending on a distance 280 from the LTE 23 dBm aggressor to the WiFi victim, wherein the interference level 278 that the WiFi victim experiences may generally increase as the distance 280 from the LTE 23 dBm aggressor to the WiFi victim decreases. Furthermore, a desensitization level 282 experienced at the WiFi victim may generally increase as the released spectrum portion 272 that the LTE 23 dBm aggressor uses to conduct the LTE operations approaches the guard band between the released spectrum portion 272 in the B40 band and the ISM band 276. Accordingly, as depicted at 284, the WiFi victim may experience increasing desense as the distance 280 from the LTE 23 dBm aggressor to the WiFi victim decreases, and may experience further increased desense as the LTE operations associated with the LTE 23 dBm aggressor are conducted at higher frequencies within the released spectrum portion 272 within the B40 band.

However, those skilled in the art will appreciate that the cross-device coexistence impacts that may result from different wireless devices conducting operations in various frequency bands and/or using various RATs may vary depending on various factors. For example, the graph depicted at 278 generally illustrates cross-device coexistence impacts where another wireless device (“Device B”) having a different WLAN receiver experiences desensitization from a 5 MHz wide TDD LTE interferer at a ˜20 meter distance. In particular, the graph shown at 278 may depict experimental results in which the vertical axis represents increasing desensitization levels at Device B, wherein the desensitization levels may vary depending on a center frequency offset from a low band edge in the ISM band 276 and a distance from the TDD LTE interferer to Device B. For example, as depicted at 292, Device B may start to experience a desensitization level over ˜10 dB where the TDD LTE interferer uses a 2.5 MHz center frequency offset from the low band edge in the ISM band 276 and a distance 296 from Device B to the TDD LTE interferer is ˜22 meters. Furthermore, at a ˜6 meter distance from the TDD LTE interferer, Device B may start to experience a desensitization level over ˜10 dB where the TDD LTE interferer uses a ˜30.0 MHz center frequency offset from the low band edge in the ISM band 276, a desensitization level over ˜30 dB where the TDD LTE interferer uses a ˜15.0 MHz center frequency offset from the low band edge in the ISM band 276, and so on.

Accordingly, solutions are needed for mitigating cross-device interference. The present disclosure is directed to coexistence management across RATs and across devices. Coexistence management may involve the use of a common signaling mechanism for the exchange of control plane data. The common signaling mechanism may be implemented using device-to-device (D2D) signaling protocols (also known as peer-to-peer (P2P) signaling protocols). Examples of D2D (or P2P) signaling protocols include Long-Term Evolution Direct (LTE-D), AllJoyn, WiFi-Direct, WiFi Aware, Bluetooth, Bluetooth Low Energy (BTLE), etc. Alternatively, the signaling may involve a WLAN access point.

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention. The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation. Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

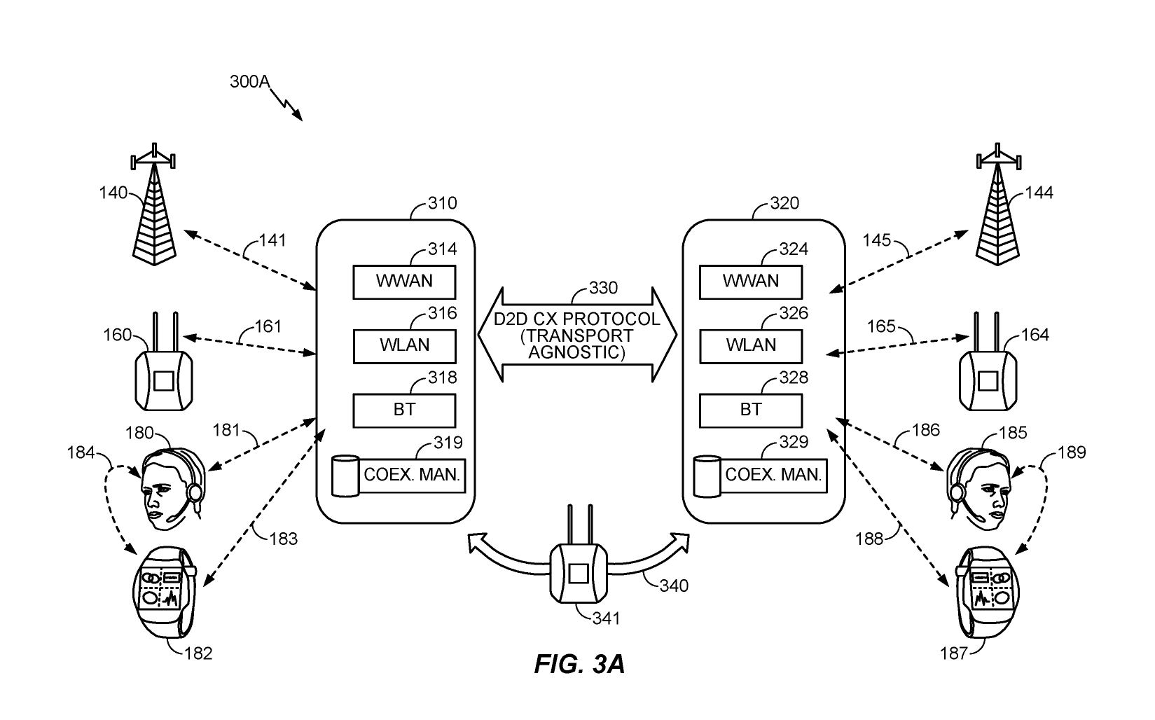

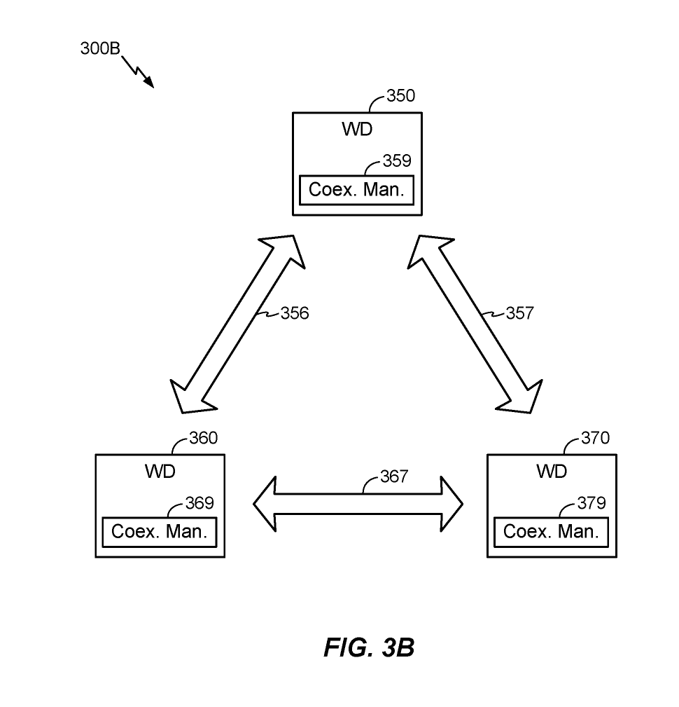

FIG. 3A generally illustrates a wireless environment 300A in which techniques for mitigation of cross-device interference are implemented. The wireless environment 300A comprises a first wireless device 310 and a second wireless device 320. The first wireless device 310 (analogous to the first wireless device 110 of FIG. 1) includes a WWAN radio 314 (analogous to the WWAN radio 114 of FIG. 1), a WLAN radio 316 (analogous to the WLAN radio 116 of FIG. 1), and a Bluetooth radio 318 (analogous to the Bluetooth radio 118 of FIG. 1). Like the first wireless device 110, the first wireless device 310 communicates with base station 140 via WWAN link 141, with access point 160 via WLAN link 161, and with Bluetooth devices 180, 182 via Bluetooth links 181, 183. The second wireless device 320 (analogous to the second wireless device 120 of FIG. 1) includes a WWAN radio 324 (analogous to the WWAN radio 124 of FIG. 1), a WLAN radio 326 (analogous to the WLAN radio 126 of FIG. 1), and a Bluetooth radio 328 (analogous to the Bluetooth radio 128 of FIG. 1). Like the second wireless device 120, the second wireless device 320 communicates with base station 144 via WWAN link 145, with access point 164 via WLAN link 165, and with Bluetooth devices 185, 187 via Bluetooth links 186, 188. As used herein, a radio may also be referred to as a transceiver.

Unlike the first wireless device 110, the first wireless device 310 further includes a coexistence manager 319 that is configured to attempt mitigation of cross-device interference. Moreover, the second wireless device 320 further includes a coexistence manager 329 that is configured to attempt mitigation of cross-device interference. Additionally or alternatively, the coexistence managers 319, 329 may be used to manage ‘in-device’ coexistence. For example, in scenarios where the operations of a first radio interfere with operations of a second radio within the same wireless device (a ‘co-located’ radio), the coexistence managers 319, 329 may be used to manage operations of the radios within the respective wireless devices 310, 320.

The coexistence managers 319, 329 may each include a processor and memory, wherein the memory is coupled to the processor and is configured to store data, instructions, or a combination thereof. Additionally or alternatively, the coexistence managers 319, 329 may be partly or wholly subsumed by host system functionality (e.g., processor and memory coupled to the processor and configured to store data, instructions, or a combination thereof) associated with the respective wireless devices.

The wireless devices 310, 320 attempt to mitigate cross-device interference by exchanging control plane data via a transport-agnostic coexistence protocol. The control plane data may be exchanged via a D2D link 330. As noted above, the D2D link 330 may utilize any D2D protocol, including, for example, LTE-D, WiFi Direct, WiFi Aware, Bluetooth, BTLE, etc. As will be understood, the D2D link 330 may be established between WWAN radio 314 and WWAN radio 324, WLAN radio 316 and WLAN radio 326, Bluetooth radio 318 and Bluetooth radio 328, and or any other radios configured to perform D2D operations. Additionally or alternatively, the control plane data may be exchanged between the first wireless device 310 and the second wireless device 320 via a WLAN link 340. The WLAN link 340 may be established via a WLAN access point 341.

The wireless devices 310, 320 may be mobile or stationary, and may communicate with a radio access network (RAN). As used herein, the term “wireless device” may be referred to interchangeably as an “access terminal” or “AT”, a “client device”, a “subscriber device”, a “subscriber terminal”, a “subscriber station”, a “user equipment” (or UE), a “user terminal” (or UT), a “mobile terminal”, a “mobile station” and variations thereof. Wireless devices can be embodied by any of a number of types of devices including but not limited to PC cards, compact flash devices, external or internal modems, wireless or wireline phones or tablets, and so on. A wireless device may be embodied by a smartphone, tablet, laptop, or personal computer, or may be part of a larger device or system, for example, a healthcare device, automobile, appliance, or network of devices (for example, a device residing in an Internet of Things (IoT) environment and/or communicating using machine-to-machine (M2M) technology). In some implementations, a wireless device may be a jammer device.

FIG. 3B generally illustrates a wireless environment 300B in which techniques for mitigation of cross-device interference may be implemented. The wireless environment 300B comprises a first wireless device 350, a second wireless device 360, and a third wireless device 370. The wireless devices 350, 360, 370 may be analogous to the first wireless device 310 and the second wireless device 320 of FIG. 3A. For example, each of the wireless devices 350, 360, 370 may include a WWAN radio, a WLAN radio, and/or a Bluetooth radio analogous to the WWAN radio 314, WLAN radio 316, and Bluetooth radio 318 of FIG. 3A. Moreover, the wireless devices 350, 360, 370 may communicate with a base station, an access point, and/or a Bluetooth device via links analogous to the WWAN link 141, WLAN link 161, and Bluetooth links 181, 183 of FIG. 1.

Like the first wireless device 310 and the second wireless device 320 of FIG. 3A, the wireless devices 350, 360, 370 further include coexistence managers 359, 369, 379, respectively. The coexistence managers 359, 369, 379 may be configured to attempt mitigation of cross-device interference. The coexistence managers 359, 369, 379 may also be used to manage ‘in-device’ coexistence. For example, in scenarios where the operations of a first radio interfere with operations of a second radio within the same wireless device (a ‘co-located’ radio), the coexistence managers 359, 369, 379 may be used to manage operations of the radios within the respective wireless devices 350, 360, 370.

The coexistence managers 359, 369, 379 may comprise a processor and memory, wherein the memory is coupled to the processor and is configured to store data, instructions, or a combination thereof. Additionally or alternatively, the coexistence managers 359, 369, 379 may be partly or wholly subsumed by host system functionality (e.g., processor and memory coupled to the processor and configured to store data, instructions, or a combination thereof) associated with the respective wireless devices.

The wireless devices 350, 360, 370 may attempt to mitigate cross-device interference by exchanging control plane data via a transport-agnostic coexistence protocol. The control plane data may be exchanged via D2D links 356, 357, 367. The D2D links 356, 357, 367 may utilize any D2D protocol, including, for example, LTE-D, WiFi Direct, WiFi Aware, Bluetooth, BTLE, etc. As will be understood, the D2D links 356, 357, 367 may be established between respective WWAN radios of one or more of the wireless devices 350, 360, 370, respective WLAN radios of the wireless devices 350, 360, 370, respective Bluetooth radios of the wireless devices 350, 360, 370, or any other radios configured to perform D2D operations. Additionally or alternatively, the control plane data may be exchanged between the respective wireless devices via a WLAN link (not shown). The WLAN link may be established via a WLAN access point.

The wireless devices 350, 360, 370 may be mobile or stationary, and may communicate with a radio access network (RAN).

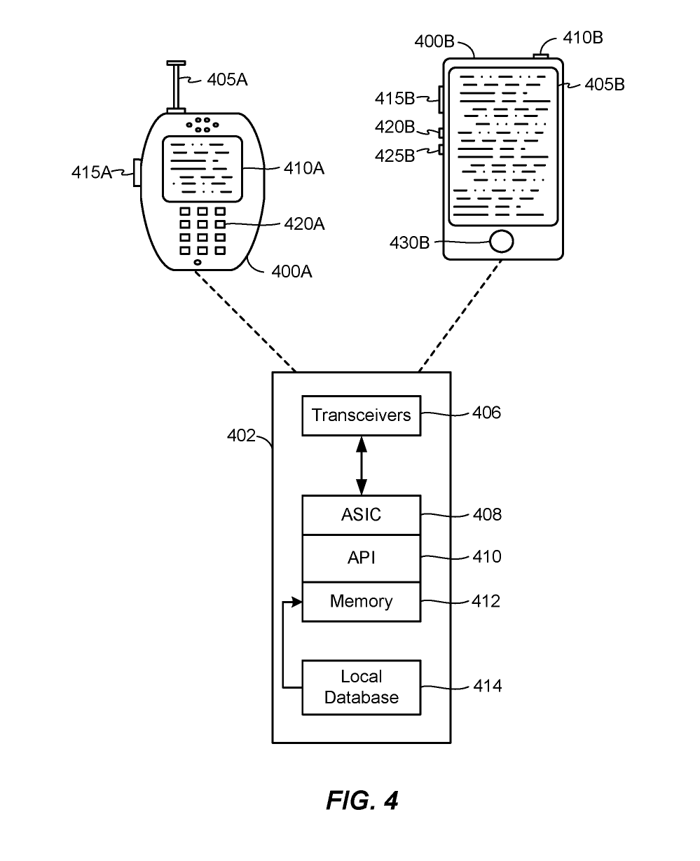

FIG. 4 illustrates some particular examples of wireless devices in accordance with embodiments of the invention. Referring to FIG. 4, wireless device 400A is illustrated as a calling telephone and wireless device 400B is illustrated as a touchscreen device (e.g., a smart phone, a tablet computer, etc.). The wireless devices 400A, 400B may correspond to any of the above-noted communication devices, including but not limited to wireless devices 310, 320, 350, 360, 370. As shown in FIG. 4, an external casing of wireless device 400A is configured with an antenna 405A, display 410A, at least one button 415A (e.g., a PTT button, a power button, a volume control button, etc.) and a keypad 420A among other components, as is known in the art. Also, an external casing of wireless device 400B is configured with a touchscreen display 405B, peripheral buttons 410B, 415B, 420B and 425B (e.g., a power control button, a volume or vibrate control button, an airplane mode toggle button, etc.), and at least one front-panel button 430B (e.g., a Home button, etc.), among other components, as is known in the art. While not shown explicitly as part of wireless device 400B, the wireless device 400B can include one or more external antennas and/or one or more integrated antennas that are built into the external casing of wireless device 400B, including but not limited to WiFi antennas, cellular antennas, satellite position system (SPS) antennas (e.g., global positioning system (GPS) antennas), and so on.

While internal components of wireless devices such as the wireless devices 400A and 400B can be embodied with different hardware configurations, a basic high-level wireless device configuration for internal hardware components is shown as platform 402 in FIG. 4. The platform 402 can receive and execute software applications, data and/or commands transmitted from a radio access network (RAN). The platform 402 can also independently execute locally stored applications without RAN interaction. The platform 402 can include one or more transceivers 406 operably coupled to an application specific integrated circuit (ASIC) 408, or other processor, microprocessor, logic circuit, or other data processing device. The ASIC 408 or other processor executes the application programming interface (API) 410 layer that interfaces with any resident programs in memory 412 of the wireless device. The memory 412 can be comprised of read-only or random-access memory (RAM and ROM), EEPROM, flash cards, or any memory common to computer platforms. The platform 402 also can include a local database 414 that can store applications not actively used in memory 412, as well as other data. The local database 414 is typically a flash memory cell, but can be any secondary storage device as known in the art, such as magnetic media, EEPROM, optical media, tape, soft or hard disk, or the like.

Accordingly, an embodiment of the invention can include a wireless device (e.g., wireless device 400A, 400B, etc.) including the ability to perform the functions described in the present disclosure. As will be appreciated by those skilled in the art, the various logic elements can be embodied in discrete elements, software modules executed on a processor or any combination of software and hardware to achieve the functionality disclosed herein. For example, ASIC 408, memory 412, API 410 and local database 414 may all be used cooperatively to load, store and execute the various functions disclosed herein and thus the logic to perform these functions may be distributed over various elements. Alternatively, the functionality could be incorporated into one discrete component. Therefore, the features of the wireless devices 400A and 400B in FIG. 4 are to be considered merely illustrative and the invention is not limited to the illustrated features or arrangement.

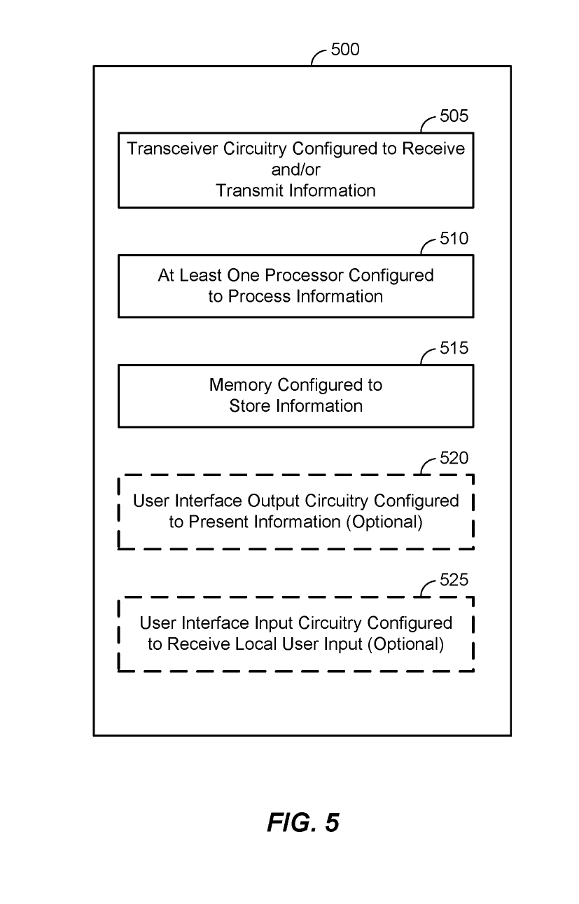

FIG. 5 illustrates a communications device 500 that includes structural components in accordance with an embodiment of the disclosure. The communications device 500 can correspond to any of the above-noted communications devices, including but not limited to wireless devices 310, 320, 350, 360, 370, 400A, and 400B. Thus, communications device 500 can correspond to any electronic device that is configured to communicate with (or facilitate communication with) one or more other entities over the wireless communications systems 100 of FIG. 1.

Referring to FIG. 5, the communications device 500 includes transceiver circuitry configured to receive and/or transmit information 505. In an example, if the communications device 500 corresponds to a wireless communications device (e.g., wireless device 310, 320, 350, 360, 370, 400A, or 400B), the transceiver circuitry configured to receive and/or transmit information 505 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to receive and/or transmit information 505 can correspond to a wired communications interface (e.g., a serial connection, a USB or Firewire connection, an Ethernet connection through which the Internet can be accessed, etc.). In a further example, the transceiver circuitry configured to receive and/or transmit information 505 can include sensory or measurement hardware by which the communications device 500 can monitor its local environment (e.g., an accelerometer, a temperature sensor, a light sensor, an antenna for monitoring local RF signals, etc.). The transceiver circuitry configured to receive and/or transmit information 505 can also include software that, when executed, permits the associated hardware of the transceiver circuitry configured to receive and/or transmit information 505 to perform its reception and/or transmission function(s). However, the transceiver circuitry configured to receive and/or transmit information 505 does not correspond to software alone, and the transceiver circuitry configured to receive and/or transmit information 505 relies at least in part upon structural hardware to achieve its functionality. Moreover, the transceiver circuitry configured to receive and/or transmit information 505 may be implicated by language other than “receive” and “transmit”, so long as the underlying function corresponds to a receive or transmit function. For an example, functions such as obtaining, acquiring, retrieving, measuring, etc., may be performed by the transceiver circuitry configured to receive and/or transmit information 505 in certain contexts as being specific types of receive functions. In another example, functions such as sending, delivering, conveying, forwarding, etc., may be performed by the transceiver circuitry configured to receive and/or transmit information 505 in certain contexts as being specific types of transmit functions. Other functions that correspond to other types of receive and/or transmit functions may also be performed by the transceiver circuitry configured to receive and/or transmit information 505.

Referring to FIG. 5, the communications device 500 further includes at least one processor configured to process information 510. Example implementations of the type of processing that can be performed by the at least one processor configured to process information 510 includes but is not limited to performing determinations, establishing connections, making selections between different information options, performing evaluations related to data, interacting with sensors coupled to the communications device 500 to perform measurement operations, converting information from one format to another (e.g., between different protocols such as .wmv to .avi, etc.), and so on. For example, the at least one processor configured to process information 510 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 510 may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The at least one processor configured to process information 510 can also include software that, when executed, permits the associated hardware of the at least one processor configured to process information 510 to perform its processing function(s). However, the at least one processor configured to process information 510 does not correspond to software alone, and the at least one processor configured to process information 510 relies at least in part upon structural hardware to achieve its functionality. Moreover, the at least one processor configured to process information 510 may be implicated by language other than “processing”, so long as the underlying function corresponds to a processing function. For an example, functions such as evaluating, determining, calculating, identifying, etc., may be performed by the at least one processor configured to process information 510 in certain contexts as being specific types of processing functions. Other functions that correspond to other types of processing functions may also be performed by the at least one processor configured to process information 510.

Referring to FIG. 5, the communications device 500 further includes memory configured to store information 515. In an example, the memory configured to store information 515 can include at least a non-transitory memory and associated hardware (e.g., a memory controller, etc.). For example, the non-transitory memory included in the memory configured to store information 515 can correspond to RAM, flash memory, ROM, erasable programmable ROM (EPROM), EEPROM, registers, hard disk, a removable disk, a CD-ROM, or any other form of storage medium known in the art. The memory configured to store information 515 can also include software that, when executed, permits the associated hardware of the memory configured to store information 515 to perform its storage function(s). However, the memory configured to store information 515 does not correspond to software alone, and the memory configured to store information 515 relies at least in part upon structural hardware to achieve its functionality. Moreover, the memory configured to store information 515 may be implicated by language other than “storing”, so long as the underlying function corresponds to a storing function. For an example, functions such as caching, maintaining, etc., may be performed by the memory configured to store information 515 in certain contexts as being specific types of storing functions. Other functions that correspond to other types of storing functions may also be performed by the memory configured to store information 515.

Referring to FIG. 5, the communications device 500 further optionally includes user interface output circuitry configured to present information 520. In an example, the user interface output circuitry configured to present information 520 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 500. For example, if the communications device 500 corresponds to the wireless device 400A and/or wireless device 400B as shown in FIG. 4, the user interface output circuitry configured to present information 520 can include the display 410A or display 405B. In a further example, the user interface output circuitry configured to present information 520 can be omitted for certain communications devices, such as network communications devices that do not have a local user (e.g., network switches or routers, remote servers, etc.). The user interface output circuitry configured to present information 520 can also include software that, when executed, permits the associated hardware of the user interface output circuitry configured to present information 520 to perform its presentation function(s). However, the user interface output circuitry configured to present information 520 does not correspond to software alone, and the user interface output circuitry configured to present information 520 relies at least in part upon structural hardware to achieve its functionality. Moreover, the user interface output circuitry configured to present information 520 may be implicated by language other than “presenting”, so long as the underlying function corresponds to a presenting function. For an example, functions such as displaying, outputting, prompting, conveying, etc., may be performed by the user interface output circuitry configured to present information 520 in certain contexts as being specific types of presenting functions. Other functions that correspond to other types of storing functions may also be performed by the user interface output circuitry configured to present information 520.

Referring to FIG. 5, the communications device 500 further optionally includes user interface input circuitry configured to receive local user input 525. In an example, the user interface input circuitry configured to receive local user input 525 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communications device 500. For example, if the communications device 500 corresponds to wireless device 400A or wireless device 400B as shown in FIG. 4, the user interface input circuitry configured to receive local user input 525 can include the buttons 420A, the display 410A (if a touchscreen), etc. In a further example, the user interface input circuitry configured to receive local user input 525 can be omitted for certain communications devices, such as network communications devices that do not have a local user (e.g., network switches or routers, remote servers, etc.). The user interface input circuitry configured to receive local user input 525 can also include software that, when executed, permits the associated hardware of the user interface input circuitry configured to receive local user input 525 to perform its input reception function(s). However, the user interface input circuitry configured to receive local user input 525 does not correspond to software alone, and the user interface input circuitry configured to receive local user input 525 relies at least in part upon structural hardware to achieve its functionality. Moreover, the user interface input circuitry configured to receive local user input 525 may be implicated by language other than “receiving local user input”, so long as the underlying function corresponds to a receiving local user function. For an example, functions such as obtaining, receiving, collecting, etc., may be performed by the user interface input circuitry configured to receive local user input 525 in certain contexts as being specific types of receiving local user functions. Other functions that correspond to other types of receiving local user input functions may also be performed by the user interface input circuitry configured to receive local user input 525.

Referring to FIG. 5, while the configured structural components of 505 through 525 are shown as separate or distinct blocks in FIG. 5 that are implicitly coupled to each other via an associated communication bus (not shown expressly), it will be appreciated that the hardware and/or software by which the respective configured structural components of 505 through 525 performs their respective functionality can overlap in part. For example, any software used to facilitate the functionality of the configured structural components of 505 through 525 can be stored in the non-transitory memory associated with the memory configured to store information 515, such that the configured structural components of 505 through 525 each performs their respective functionality (i.e., in this case, software execution) based in part upon the operation of software stored by the memory configured to store information 515. Likewise, hardware that is directly associated with one of the configured structural components of 505 through 525 can be borrowed or used by other of the configured structural components of 505 through 525 from time to time. For example, the at least one processor configured to process information 510 can format data into an appropriate format before being transmitted by the transceiver circuitry configured to receive and/or transmit information 505, such that the transceiver circuitry configured to receive and/or transmit information 505 performs its functionality (i.e., in this case, transmission of data) based in part upon the operation of structural hardware associated with the at least one processor configured to process information 510.

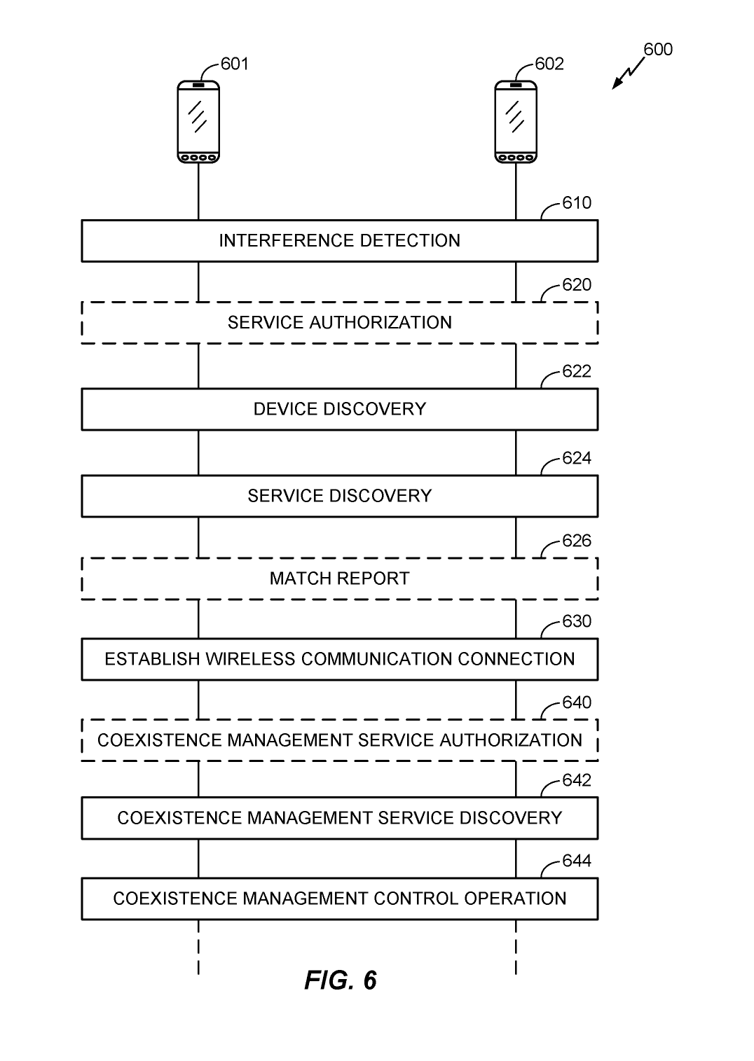

FIG. 6 generally illustrates a flow diagram for a method 600 for improving coexistence between wireless devices in accordance with an aspect of the disclosure. FIG. 6 depicts two wireless devices 601, 602; however, it will be understood that any number of devices may utilize the method 600 for improving coexistence in accordance with aspects of the disclosure. The wireless devices 601, 602 may be analogous to any of the wireless devices described in the present disclosure (wireless devices 310, 320, 350, 360, 370, 400A, 400B, communication device 500, etc.).

At 610, the wireless devices 601, 602 detect interference. The wireless device that detects the interference may be referred to as a “victim device”. As noted above, operations of a wireless device can cause cross-device, cross-RAT interference with a proximate wireless device. Accordingly, if wireless devices 601, 602 are proximate to one another, then the likelihood and impact of cross-device interference increases. According to one possible example, detection of interference by a victim device is based on a measured value of received signal strength (for example, a received signal strength indicator, or “RSSI”). If the RSSI exceeds an RSSI threshold, then the victim device may rely on the techniques of the present disclosure to improve coexistence. It will be understood that other interference thresholds can be used that are not RSSI-based. Additionally or alternatively, the victim device may detect an interfering jammer device using a jammer detector.

As noted above, the interference experienced by the victim device may be caused by a proximate wireless device operating on a different RAT and/or frequency. The proximate wireless device that causes the interference may be referred to as an “aggressor device”. Depending on the circumstances, either of the wireless devices 601, 602 may be an aggressor device and either of the wireless devices 601, 602 may be a victim device.

The interference detection of 610 may be performed by any suitable component or components of the wireless devices 601, 602. For example, the interference detection of 610 may be performed, in part or in whole, by components analogous to the WWAN radio 314, WLAN radio 316, and Bluetooth radio 318 (or the WWAN radio 324, WLAN radio 326, and Bluetooth radio 328) of FIG. 3A. Additionally or alternatively, the interference detection of 610 may be performed by other hardware and software components (for example, processors and memories) included in the wireless devices 601, 602. These components may perform the interference detection of 610 in tandem with, for example, a coexistence manager analogous to coexistence managers 319, 329 of FIG. 3A. In some implementations, the coexistence manager may be constituted by a processor and memory (not shown). The processor and memory may be a central processor and central memory associated with the wireless device, a processor and memory associated with one or more of the radios 314, 316, 318, 324, 326, 328, or an independent processor and memory configured to manage coexistence. The coexistence manager may include other hardware, firmware, or software elements as well, and may compose radio frequency circuitry.

It will be understood that the wireless device arrangements of FIGS. 4-5 may also be used to perform the interference detection of 610. The wireless devices 400A and 400B may utilize one or more of the transceivers 406, ASIC 408 and/or memory 412 to perform the interference detection of 610 and the communication device 500 may utilize one or more of the logic configured to receive and/or transmit information 505, logic configured to process information 510, and logic configured to store information 515 to perform the interference detection of 610.

At 620-626, the wireless devices 601, 602 discover each other. The discovery of 620-626 may be initiated and/or performed, as necessary, in accordance with known methods. For example, discovery can be performed in accordance with the technical specifications set forth by the Third-Generation Partnership Project (for example, 3GPP TS 23.303, “Proximity-based services (ProSe); Stage 2”) or the WiFi Alliance (for example, WiFi Peer-to-Peer Services (P2Ps) Technical Specification). The above-noted discovery techniques may be known by other names. Moreover, other variations and/or alternatives are known. A non-exclusive list of suitable discovery protocols includes LTE-Direct discovery protocol, WiFi-Direct discovery protocol, AllJoyn discovery protocol, WiFi Aware discovery protocol, Bluetooth discover protocol, and Bluetooth Low Energy (BTLE) discovery protocol.

At 620, each wireless device 601, 602 optionally performs service authorization. During service authorization, each wireless device 601, 602 establishes its ability to communicate with proximate devices. For example, each of the wireless devices 601, 602 may establish (via a surrounding 3GPP network) that they can operate in accordance with the 3GPP proximity services protocol. In the event that the wireless devices 601, 602 are sufficiently proximate to one another, the wireless devices 601, 602 can use the 3GPP proximity services protocol to discover one another. It will be understood that the service authorization of 620 is optional. For example, the WiFi P2P services protocol may not require the service authorization of 620. It will be understood that the service authorization of 620 may be performed (or not performed) in accordance with any suitable protocol in accordance with the proper technical specifications.

At 622, each wireless device 601, 602 performs device discovery. During device discovery, a wireless device such as wireless device 601 or wireless device 602 establishes a link with another proximate device. The link can be set up by, for example, exchanging device names. Under the 3GPP proximity-based services protocol, the device names are referred to as ProSe UE IDs, although it will be understood that naming conventions may vary among different discovery protocols. It will be understood that the device discovery operations at 622 may be performed (or not performed) in accordance with any suitable protocol in accordance with the proper technical specifications.

At 624, each wireless device 601, 602 performs service discovery. During service discovery, the wireless devices 601, 602 exchange data concerning their respective services and capabilities. It will be understood that the device discovery operations at 624 may be performed (or not performed) in accordance with any suitable protocol in accordance with the proper technical specifications.

At 626, each wireless device 601, 602 optionally performs a match report. Like the service authorization at 620, the match report at 626 is optional. In the case of 3GPP, the match report at 626 may be used to establish that the wireless devices 601, 602 can communicate. However, the wireless device P2P services protocol may not require the match report of 626. It will be understood that the match report of 626 may be performed (or not performed) in accordance with any suitable protocol in accordance with the proper technical specifications.

The discovery of 620-626 enables each of the wireless devices 601, 602 to discover one or more proximate devices. As noted above, the interference experienced by the victim device may be caused by a proximate aggressor device operating on a different RAT and/or frequency. By identifying one or more proximate devices, the victim device can proceed to identify which of the proximate devices are aggressor devices and/or what operations of the aggressor device(s) are causing the interference.

The discovery of 620-626 may be performed by any suitable component or components of the wireless devices 601, 602. For example, the discovery of 620-626 may be performed, in part or in whole, by components analogous to the WWAN radio 314, WLAN radio 316, and Bluetooth radio 318 (or the WWAN radio 324, WLAN radio 326, and Bluetooth radio 328) of FIG. 3A. These components may perform the discovery of 620-626 in tandem with, for example, a coexistence manager analogous to coexistence managers 319, 329 of FIG. 3A. In some implementations, the coexistence manager may be constituted by a processor and memory (not shown). The processor and memory may be a central processor and central memory associated with the wireless device, a processor and memory associated with one or more of the radios 314, 316, 318, 324, 326, 328, or an independent processor and memory configured to manage coexistence. It will be understood that the wireless device arrangements of FIGS. 4-5 may also be used to perform the discovery of 620-626. The wireless devices 400A and 400B may utilize one or more of the transceivers 406, ASIC 408 and memory 412 to perform the discovery of 620-626 and the communication device 500 may utilize one or more of the logic configured to receive and/or transmit information 505, logic configured to process information 510, and logic configured to store information 515 to perform the discovery of 620-626.

At 630, the wireless devices 601, 602 establish a wireless communication connection. In some scenarios, the wireless communication connection may be established at 630 using the same RAT as was used to perform discovery at 620-626. However, the wireless communication connection may be established at 630 using any suitable technique. In one possible implementation, the wireless communication connection is established at 630 over a D2D (or P2P) wireless communication connection (such as, for example, the D2D link 330 shown in FIG. 3A, the D2D links 356, 357, 367 shown in FIG. 3B, etc.). A non-exclusive list of suitable D2D communication techniques may include LTE-Direct (“LTE-D”), WiFi-Direct, Bluetooth, and Bluetooth Low Energy (BTLE). Alternatively, the wireless communication connection may be established via another entity. For example, the wireless communication connection may be established at 630 over a WLAN access point (such as, for example, the WLAN link 340 in FIG. 3A, established via the WLAN access point 341). The resulting connection may be an LTE-D connection, a WiFi-Direct connection, a WiFi Aware connection, an AllJoyn connection, a Bluetooth connection, a Bluetooth Low Energy (BTLE) connection, or a WLAN access point connection.

The wireless communication connection establishment of 630 may be performed by any suitable component or components of the wireless devices 601, 602. For example, the wireless communication connection establishment of 630 may be performed, in part or in whole, by components analogous to the WWAN radio 314, WLAN radio 316, and Bluetooth radio 318 (or the WWAN radio 324, WLAN radio 326, and Bluetooth radio 328) of FIG. 3A. These components may perform the wireless communication connection establishment of 630 in tandem with, for example, a coexistence manager analogous to coexistence managers 319, 329 of FIG. 3A. In some implementations, the coexistence manager may be constituted by a processor and memory (not shown). The processor and memory may be a central processor and central memory associated with the wireless device, a processor and memory associated with one or more of the radios 314, 316, 318, 324, 326, 328, or an independent processor and memory configured to manage coexistence. It will be understood that the wireless device arrangements of FIGS. 4-5 may also be used to perform the wireless communication connection establishment of 630. The wireless devices 400A and 400B may utilize one or more of the transceivers 406, ASIC 408 and memory 412 to perform the wireless communication connection establishment of 630 and the communication device 500 may utilize one or more of the logic configured to receive and/or transmit information 505, logic configured to process information 510, and logic configured to store information 515 to perform the wireless communication connection establishment of 630.

At 640-644, each of wireless devices 601, 602 performs signaling in accordance with a coexistence discovery protocol. The coexistence discovery protocol of 640-644 may be performed by two or more proximate wireless devices. As noted above, proximate wireless devices may be identified via the discovery of 620-626. The signaling associated with the performance of the coexistence discovery protocol of 640-644 may be performed over the wireless communication connection established at 630. Performance of the coexistence discovery protocol by either or both of the wireless devices 601, 602 may be referred to as coexistence management.

Although the interference detection of 610, the discovery of 620-626, and the wireless communication connection establishment of 630 are depicted in FIG. 6 in a particular sequence, it will be understood that they may be performed in any order. For example, the discovery of 620-626 and/or establishment of 630 may have occurred prior to the detection of interference at 610, for example, for reasons that are unrelated to mitigation of interference. For example, if a proximate device has already been discovered and a wireless communication connection has already been established with the proximate device, then the method 600 may proceed directly from detection of interference (as is performed at 610) to the coexistence discovery protocol of 640-644.

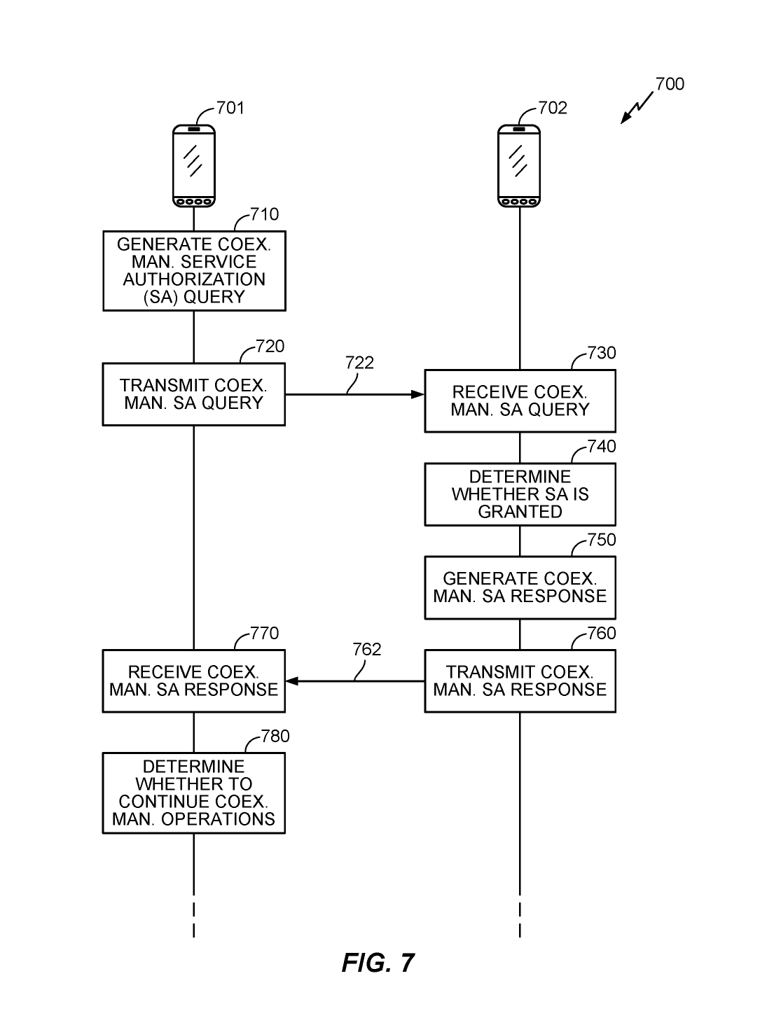

At 640, the wireless devices 601, 602 optionally perform coexistence management service authorization. In one possible scenario, the victim device selects one of the proximate wireless devices identified during performance of discovery at 620-626 and performs the coexistence management service authorization of 640 over the wireless communication connection established at 630. As a result of the coexistence management service authorization of 640, the victim device can determine whether the selected proximate wireless device is willing and/or able to work with the victim device to attempt to mitigate interference. A more detailed explanation of the coexistence management service authorization of 640 is set forth in, for example, FIG. 7 and the related description.

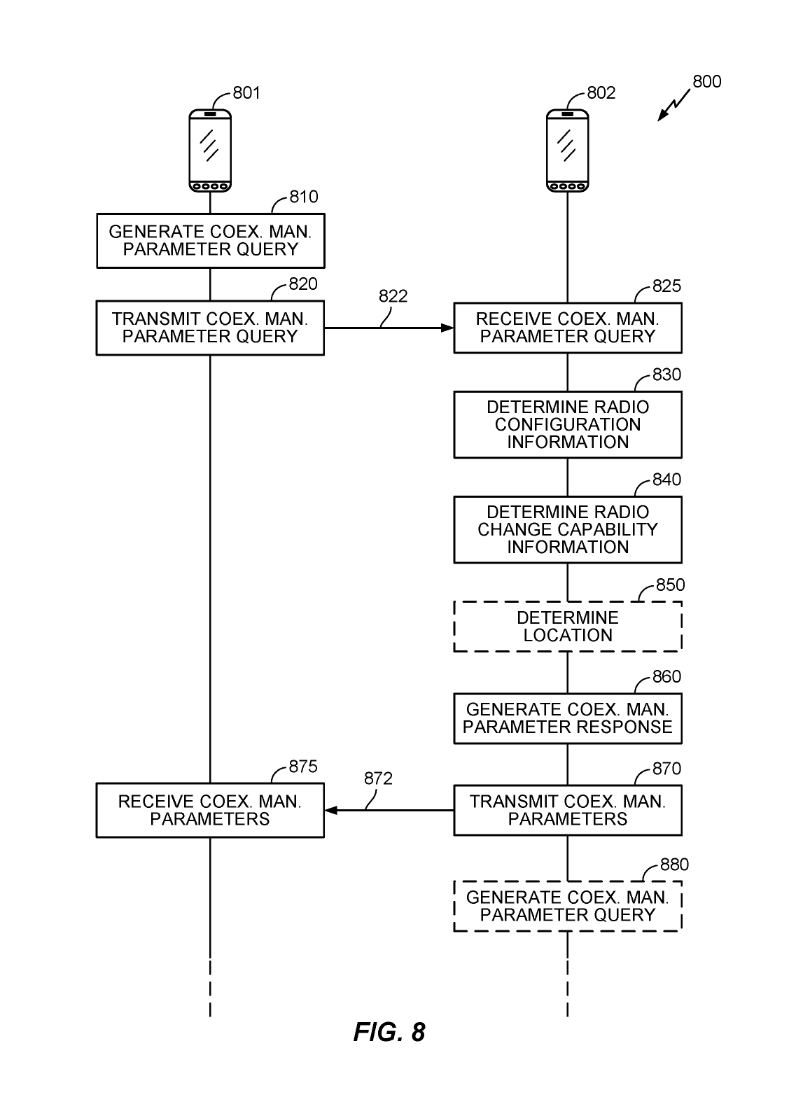

At 642, the wireless devices 601, 602 perform coexistence management service discovery. In one possible scenario, the victim device and selected proximate wireless device exchange coexistence management parameters over the wireless communication connection established at 630. The coexistence management service discovery of 642 may be responsive to positive authorization during performance of the coexistence management service authorization of 640. As a result of the coexistence management service discovery of 642, the victim device and the selected proximate wireless device can transmit and/or receive information related to, for example, their respective radio configurations, their respective radio change capabilities, and/or their respective locations. A more detailed explanation of the coexistence management service discovery of 642 is set forth in, for example, FIG. 8 and the related description.

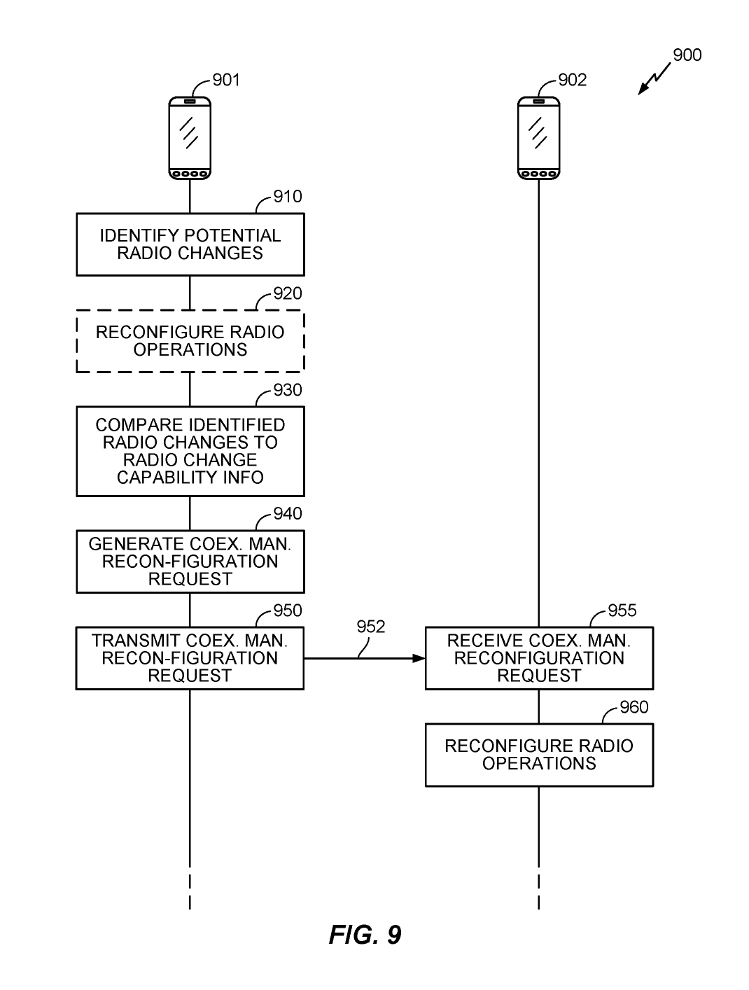

At 644, the wireless devices 601, 602 perform coexistence management control operation. In one possible scenario, the coexistence management parameters exchanged during the coexistence management service discovery of 642 enable the victim device to determine whether the selected proximate wireless device is causing the interference detected at 610. In other words, the coexistence management control operation of 644 may enable the victim device to identify the aggressor device that is causing (or partially causing) the cross-device, cross-RAT interference. In one possible scenario, the victim device uses information related to the interference detected at 610 and radio configuration information obtained from the proximate wireless device at 642 to identify the aggressor device. The coexistence management control operation of 644 may also enable the victim device to determine a potential radio change or set of potential radio changes that will mitigate the cross-device, cross-RAT interference. In some cases, the potential radio changes can be performed by the victim device itself, and in other cases, the potential radio changes must be performed by the aggressor device. Accordingly, at 644, the victim device may perform a radio change and/or request that the aggressor device perform a radio change. A more detailed explanation of the coexistence management control operation of 644 is set forth in, for example, FIG. 9 and the related description.

The coexistence discovery protocol of 640-644 may be performed by any suitable component or components of the wireless devices 601, 602. For example, the coexistence discovery protocol of 640-644 may be performed, in part or in whole, by components analogous to the WWAN radio 314, WLAN radio 316, and Bluetooth radio 318 (or the WWAN radio 324, WLAN radio 326, and Bluetooth radio 328) of FIG. 3A. These components may perform the coexistence discovery protocol of 640-644 in tandem with, for example, a processor and memory (not shown). Additionally or alternatively, these components may perform the coexistence discovery protocol of 640-644 in tandem with the coexistence manager 319 (or coexistence manager 329) of FIG. 3A. In one possible scenario, the coexistence manager 319 (or coexistence manager 329) of FIG. 3A generates the signals necessary for performing the coexistence discovery protocol of 640-644 by including relevant information in the signals and directing them to the radio over which the wireless communication connection is established at 630. In some implementations, the coexistence manager may be constituted by a processor and memory (not shown). The processor and memory may be a central processor and central memory associated with the wireless device, a processor and memory associated with one or more of the radios 314, 316, 318, 324, 326, 328, or an independent processor and memory configured to manage coexistence. It will be understood that the wireless device arrangements of FIGS. 4-5 may also be used to perform the coexistence discovery protocol of 640-644. The wireless devices 400A and 400B may utilize one or more of the transceivers 406, ASIC 408 and memory 412 to perform the coexistence discovery protocol of 640-644 and the communication device 500 may utilize one or more of the logic configured to receive and/or transmit information 505, logic configured to process information 510, and logic configured to store information 515 to perform the coexistence discovery protocol of 640-644.

As noted above, the method 600 depicts a method for improving coexistence between two wireless devices in accordance with an aspect of the disclosure. However, it will be understood that if a first performance of method 600 fails (or alternatively, does not satisfactorily mitigate interference), then a second performance of method 600 may be performed. The second performance may involve different radio knobs or parameters, or may involve an entirely different wireless device. For example, if the wireless device 601 detects interference, it may perform the method 600 in tandem with the wireless device 602, as shown in FIG. 6. If the method 600 fails to mitigate the interference (or fails to mitigate it sufficiently), then the wireless device 601 may perform the method 600 again in order to manage coexistence using different radio parameters. Additionally or alternatively, the wireless device 601 may perform the method 600 in tandem with a different wireless device (not shown).

Moreover, if the wireless device 601 detects interference and also detects multiple proximate wireless devices, it may perform the method 600 with each wireless device simultaneously or sequentially. In some scenarios, the method 600 is continually performed with additional proximate wireless devices until the interference is sufficiently mitigated, or until the method 600 is performed with every proximate wireless device.

Although FIG. 6 shows two wireless devices 601, 602, it will be understood that any number of wireless devices may utilize the method 600 for improving coexistence in accordance with aspects of the disclosure.

FIG. 7 generally illustrates a signal flow diagram 700 for coexistence management service authorization. The coexistence management service authorization of signal flow diagram 700 may be analogous to, for example, the coexistence management service authorization 640 of FIG. 6. FIG. 7 depicts two wireless devices 701, 702. The wireless devices 701, 702 may be analogous to any of the wireless devices described in the present disclosure (wireless devices 310, 320, 350, 360, 370, 400A, 400B, communication device 500, wireless devices 601, 602, etc.). In the following description, the wireless device 701 is a victim device that has detected interference (as in 610 of FIG. 6) and the wireless device 702 is a proximate wireless device that has been discovered by the victim device (as in 620-626 of FIG. 6). The signals in signal flow diagram 700 are transmitted via an established wireless communication connection (as in 630 of FIG. 6).

At 710, the victim device 701 generates a coexistence management service authorization query. The coexistence management service authorization query is configured to be communicated over a wireless communication connection established between the victim device 701 and a proximate wireless device 702. The coexistence management service authorization query is further configured to prompt the proximate wireless device 702 to determine whether to grant service authorization. Accordingly, the coexistence management service authorization query generated at 710 may include any information which assists the proximate wireless device 702 in determining whether the service authorization should be granted. For example, the query may include a request to participate in coexistence management, information on the identity of the victim device 701, etc.

At 720, the victim device 701 transmits the coexistence management service authorization query generated at 710 as a coexistence management service authorization query signal 722. The coexistence management service authorization query signal 722 is transmitted over the wireless communication connection established between the victim device 701 and a proximate wireless device 702. At 730, the proximate wireless device 702 receives the coexistence management service authorization query signal 722.

At 740, the proximate wireless device 702 determines whether to grant or deny service authorization. The determination at 740 may be responsive to receipt of the coexistence management service authorization query signal 722 at 730. The proximate wireless device 702 may determine whether to grant or deny service authorization on the basis of any of the information included in the coexistence management service authorization query signal 722. Additionally or alternatively, the proximate wireless device 702 may determine whether to grant or deny service authorization on the basis of information retrieved and/or generated locally by the proximate wireless device 702. The local information may relate to the capabilities of the proximate wireless device 702 (for example, whether the proximate wireless device 702 is equipped with coexistence management functionality), user preferences regarding coexistence management, etc.

At 750, the proximate wireless device 702 generates a coexistence management service authorization response. The generation at 750 may be responsive to the determination at 740. The coexistence management service authorization response is configured to be communicated over the wireless communication connection established between the victim device 701 and a proximate wireless device 702. The coexistence management service authorization response is further configured to notify the victim device 701 as to whether the proximate wireless device 702 is willing to participate and/or capable of participating in further coexistence management operations (for example, the coexistence management operations at 642, 644 in FIG. 6).

At 760, the proximate wireless device 702 transmits the coexistence management service authorization response generated at 750 as a coexistence management service authorization response signal 762. The coexistence management service authorization response signal 762 is transmitted over the wireless communication connection established between the victim device 701 and a proximate wireless device 702. At 770, the victim device 701 receives the coexistence management service authorization response signal 762.

At 780, the victim device 701 determines whether to continue coexistence management operations (for example, the coexistence management operations at 642, 644 in FIG. 6). The determination at 780 may be based on the coexistence management service authorization response signal 762 received at 770.

FIG. 8 generally illustrates a flow diagram 800 for coexistence management service discovery. The coexistence management service discovery of flow diagram 800 may be analogous to, for example, the coexistence management service discovery at 642 of FIG. 6. Accordingly, it may be performed in response to positive authorization during performance of the coexistence management service authorization of 640 in FIG. 6 or substantial completion of the coexistence management service authorization of signal flow diagram 700 of FIG. 7. FIG. 8 depicts two wireless devices 801, 802. The wireless devices 801, 802 may be analogous to any of the wireless devices described in the present disclosure (wireless devices 310, 320, 350, 360, 370, 400A, 400B, communication device 500, wireless devices 601, 602, 701, 702, etc.). In the following description, the wireless device 801 is a victim device that has detected interference (as in 610 of FIG. 6) and the wireless device 802 is a proximate wireless device that has been discovered by the victim device (as in 620-626 of FIG. 6). The signals in flow diagram 800 are transmitted via an established wireless communication connection (as in 630 of FIG. 6).

At 810, the victim device 801 generates a coexistence management parameter query. The coexistence management parameter query is configured to be communicated over a wireless communication connection established between the victim device 801 and a proximate wireless device 802. The coexistence management parameter query is further configured to prompt the proximate wireless device 802 to transmit coexistence management parameters. Accordingly, the coexistence management parameter query generated at 810 may include any information which assists the proximate wireless device 802 in determining which coexistence management parameters to transmit. For example, the query may include a request for radio configuration information, a request for radio change capability information, a request for location information, etc. The query may include a general request for all available radio configuration information, or a targeted request relating to a particular RAT, frequency, timing, channel, or power characteristic.

At 820, the victim device 801 transmits the coexistence management parameter query generated at 810 as a coexistence management parameter query signal 822. The coexistence management parameter query signal 822 is transmitted over the wireless communication connection established between the victim device 801 and a proximate wireless device 802. At 825, the proximate wireless device 802 receives the coexistence management parameter query signal 822.

At 830, the proximate wireless device 802 determines radio configuration information. The determination at 830 may be responsive to the coexistence management parameter query received at 825. For example, the determination at 830 may attempt to generate all or a portion of the information requested in the coexistence management parameter query signal 822. The radio configuration information may include, for example, information relating to the RAT or RATs that the proximate wireless device 802 is presently operating on. Additionally or alternatively, the radio configuration information may include information relating to the frequencies, timings, and/or channels within a given RAT that the proximate wireless device 802 is presently operating on. Additionally or alternatively, the radio configuration information may include information relating to the transmission power or received signal strength associated with the respective communications on the RATs, frequencies, timings, channels, etc., that the proximate wireless device 802 is presently operating on.

At 840, the proximate wireless device 802 determines radio change capability information. The determination at 840 may be responsive to the coexistence management parameter query received at 825. For example, the determination at 840 may attempt to generate all or a portion of the information requested in the coexistence management parameter query signal 822. The radio change capability information may include, for example, information relating to the RAT or RATs that are presently available to the proximate wireless device 802. Additionally or alternatively, the radio change capability information may include information relating to the frequencies, timings, and/or channels within a given RAT that are presently available to the proximate wireless device 802. Additionally or alternatively, the radio change capability information may include information relating to the transmission power associated with the respective communications on the RATs, frequencies, timings, channels, etc., that are presently available to the proximate wireless device 802. In some scenarios, the proximate wireless device 802 may determine that a given radio configuration is “available” because it determines that changing to the given radio configuration will have no negative impact (or limited negative impact, i.e., negative impact that is below a threshold) on its own operations.

At 850, the proximate wireless device 802 optionally determines location information. The determination at 850 may be responsive to the coexistence management parameter query received at 825. For example, the determination at 850 may attempt to generate all or a portion of the information requested in the coexistence management parameter query signal 822. The location may be determined using, for example, a global positioning satellite sensor, gyroscope sensor, accelerometer sensor, any of the transceivers with which the proximate wireless device 802 is equipped, etc. The location information may be processed by, for example, a navigational application. The location information may be used to aid in determining the impact or likelihood of interference between the wireless devices 801, 802. For example, if a given wireless device is located a long distance from the victim device 801, then it is not likely to be an aggressor device.

At 860, the proximate wireless device 802 generates a coexistence management parameter response. The coexistence management parameter response is configured to be communicated over a wireless communication connection established between the victim device 801 and a proximate wireless device 802. The coexistence management parameter response is further configured to notify the victim device 801 of one or more of the coexistence management parameters requested in the coexistence management parameter query received at 825. It will be understood that the determinations at 830, 840, 850 may be performed (if they are performed) in any order. It will further be understood that the coexistence management parameter response of 860 may include all of the information determined at 830, 840, 850 or any portion thereof. Accordingly, generation of the coexistence management parameter response at 860 may be responsive to the completion of each of the determinations 830, 840, 850, the completion of any one of the determinations 830, 840, 850, or the partial completion of any one of the determinations 830, 840, 850.

At 870, the proximate wireless device 802 transmits the coexistence management parameter response generated at 860 as a coexistence management parameter response signal 872. The coexistence management parameter response signal 872 is transmitted over the wireless communication connection established between the victim device 801 and a proximate wireless device 802. At 875, the victim device 801 receives the coexistence management parameter response signal 872.

At 880, the proximate wireless device 802 optionally generates a coexistence management parameter query. The coexistence management parameter query generated at 880 (by the proximate wireless device 802) may be analogous and reciprocal to the coexistence management parameter query generated at 810 (by the victim device 801). The coexistence management parameter query generation of 880 may be followed by additional reciprocal operations that result in a full exchange of coexistence management parameters between the victim device 801 and the proximate wireless device 802. Just as the victim device 801 performs operations 810, 820, 875 to obtain coexistence management parameters from the proximate wireless device 802, the proximate wireless device 802 can perform operations that are reciprocal to 810, 820, 875 to obtain coexistence management parameters from the victim device 801. Similarly, just as the proximate wireless device 802 performs operations 825-870 to provide the requested coexistence management parameters to the victim device 801, the victim device 801 can perform operations that are reciprocal to 825-870 to provide the requested coexistence management parameters to the proximate wireless device 802. Although the reciprocal operations are not shown (with the exception of 880), it will be understood that the reciprocal operations may be performed as an alternative to, or in addition to, the operations 810-875. Moreover, the reciprocal operations may be performed simultaneously. As used herein, the term “coexistence management parameter exchange” may refer to a single ‘one-way’ coexistence management parameter query and coexistence management parameter response or a reciprocal ‘two-way’ exchange of coexistence management parameter queries and responses.

FIG. 9 generally illustrates a signal flow diagram 900 for coexistence management control operation. The coexistence management control operation of signal flow diagram 900 may be analogous to, for example, the coexistence management control operation at 644 of FIG. 6. Accordingly, it may be performed in response to completion (or partial completion) of the coexistence management parameter exchange during performance of the coexistence management service discovery of 642 in FIG. 6 or substantial completion of the coexistence management service discovery of flow diagram 800 of FIG. 8.

FIG. 9 depicts two wireless devices 901, 902. The wireless devices 901, 902 may be analogous to any of the wireless devices described in the present disclosure (wireless devices 310, 320, 350, 360, 370, 400A, 400B, communication device 500, wireless devices 601, 602, 701, 702, 801, 802, etc.). In the following description, the wireless device 901 is a victim device that has detected interference (as in 610 of FIG. 6) and the wireless device 902 is a proximate wireless device that has been discovered by the victim device (as in 620-626 of FIG. 6). The signals in signal flow diagram 900 are transmitted via an established wireless communication connection (as in 630 of FIG. 6).

At 910, the victim device 901 identifies one or more radio changes that may potentially reduce interference. The determination at 910 may be based on interference information relating to the interference detected by the victim device 901 (as in 610 of FIG. 6) and radio configuration information received from the proximate wireless device 902 (as in 642 of FIG. 6 or 875 in FIG. 8).

The one or more radio changes may be identified at 910 in any suitable manner. For example, a lookup table may relate the detected interference and the received radio configuration information to a set of one or more selectable radio changes that will potentially mitigate the interference. The lookup table may be stored in the victim device 901 (for example, in the memory 412 of FIG. 4 or logic configured to store information 515 of FIG. 5) or remotely accessible to the victim device 901 (for example, stored on a remote server). In one possible scenario, the lookup table is maintained in the victim device 901 and updated upon the success or failure of a specific attempt at coexistence management performed by the victim device 901. Specific attempts at coexistence management may be performed by iteratively adjusting various radio characteristics in a trial-and-error manner and measuring the results (for example, whether the specific attempt succeeded or failed and, optionally, the degree to which it succeeded).

In another possible scenario, the lookup table is downloaded periodically or on an as-needed basis from the remote server (not shown). In this scenario, the downloadable lookup table may be maintained at the remote server and updated in view of interference issues known to arise in experimental settings or known to arise through practical use.

At 920, the victim device 901 optionally reconfigures the radio operations of the victim device 901. Reconfiguring of radio operations may include the changing of a RAT upon which certain operations are performed, the changing of a frequency or timing upon which certain operations are performed, the changing of a transmission power upon which certain operations are performed, etc. The victim device may also invoke interference cancellation techniques, enable baseband modifications, or change filtering configurations (for example, via switching filter paths, or coefficient control in a digital filter). The reconfiguration at 920 may be responsive to the identification of one or more potential radio changes at 910. In particular, if the identification at 910 indicates that the victim device 901 may be able to mitigate the interference by performing a particular radio change (i.e., ‘moving away’ from the interference), then the victim device 901 may perform the particular radio change at 920. If the identification at 910 does not indicate that the victim device 901 may be able to mitigate the interference by performing a particular radio change, then the reconfiguration at 920 may be omitted. The reconfiguration at 920 may also be omitted if the identification at 910 indicates that the proximate wireless device 902 is more likely or better able to mitigate the interference. If the identification at 910 indicates that the proximate wireless device 902 is more likely or better able to mitigate the interference, then the signal flow diagram 900 may proceed to 930.

At 930, the identified radio changes are compared to the radio change capability information received from the proximate wireless device 902. As noted above, reconfiguring of radio operations may include the changing of a RAT upon which certain operations are performed, the changing of a frequency or timing upon which certain operations are performed, the changing of a transmission power upon which certain operations are performed, etc. The potential radio changes may also include interference cancellation techniques, baseband modifications, or filter configuration changes (for example, via switching filter paths, or coefficient control in a digital filter). Accordingly, the radio change capability information received from the proximate wireless device 902 indicates which reconfigurations the proximate wireless device 902 is willing and/or able to perform. If a potential radio change identified at 910 is a reconfiguration that the proximate wireless device 902 is willing and/or able to perform, then the comparison is positive. In response to a positive comparison, the victim device 901 may request that the proximate wireless device 902 reconfigure its radio operations. On the other hand, if the potential radio change identified at 910 is a reconfiguration that the proximate wireless device 902 is unwilling and/or unable to perform, then the comparison is negative. If the comparison is a negative comparison, then the victim device 901 may not request that the proximate wireless device 902 reconfigure its radio operations.

At 940, the victim device 901 generates a radio reconfiguration request. In some implementations, the radio reconfiguration request may include a coexistence management reconfiguration request. The coexistence management reconfiguration request may be configured to be communicated over a wireless communication connection established between the victim device 901 and the proximate wireless device 902. The coexistence management reconfiguration request includes at least one reconfiguration request and is generated at 940 in response to at least one positive comparison at 930. As noted above, reconfiguring of radio operations may include the changing of a RAT upon which certain operations are performed, the changing of a frequency or timing upon which certain operations are performed, the changing of a transmission power upon which certain operations are performed, etc. The requested radio changes may also include interference cancellation techniques, baseband modifications, or filter configuration changes (for example, via switching filter paths, or coefficient control in a digital filter). Accordingly, the coexistence management reconfiguration request generated at 940 identifies one or more of the aforementioned radio operation characteristics.

At 950, the victim device 901 transmits the coexistence management reconfiguration request generated at 940 as a coexistence management reconfiguration request signal 952. The coexistence management reconfiguration request signal 952 is transmitted over the wireless communication connection established between the victim device 901 and the proximate wireless device 902. At 955, the proximate wireless device 902 receives the coexistence management reconfiguration request signal 952.

At 960, the proximate wireless device 902 reconfigures the radio operations of the victim device 901. The reconfiguration at 960 may be responsive to the reception at 955 of the coexistence management reconfiguration request signal 952. Reconfiguring of radio operations may include the changing of a RAT upon which certain operations are performed, the changing of a frequency or timing upon which certain operations are performed, the changing of a transmission power upon which certain operations are performed, etc. The radio configuration changes performed by the proximate wireless device 902 may also include interference cancellation techniques, baseband modifications, or filter configuration changes (for example, via switching filter paths, or coefficient control in a digital filter). The reconfiguration at 960 may optionally be followed by the sending of a radio reconfiguration notification (not shown) to the victim device 901.

FIG. 9 details a scenario in which the victim device 901 has obtained the coexistence management parameters of the proximate wireless device 902 and proceeds to generate a radio reconfiguration request (at 940) for transmission to the proximate wireless device 902 (at 950). It will be understood, however, that the proximate wireless device 902 may be equally capable of performing the operations of 910 and 930. In other words, if the proximate wireless device 902 has obtained the coexistence management parameters of the victim device 901 (as in 880, etc., of FIG. 8), then the proximate wireless device 902 can (by itself) perform the identification of potential radio changes, and can (by itself) determine whether it is willing and/or able to reconfigure.

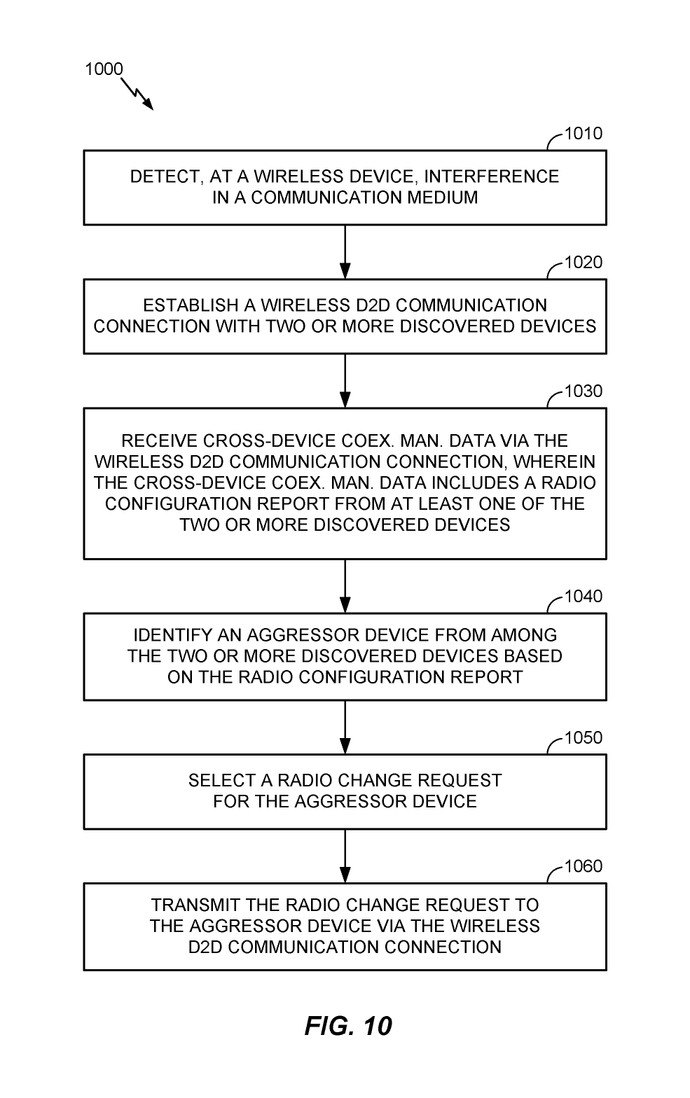

FIG. 10 generally illustrates a method 1000 for improving coexistence among three or more wireless devices. The method 1000 may be performed by, for example, a wireless device analogous to the wireless devices 310, 320, 350, 360, 370, 400A, 400B, 500, etc. However, for the purpose of illustration, the method 1000 will be described herein as it would be performed by the wireless device 350 of FIG. 3B.

At 1010, the wireless device 350 detects interference in a communication medium. The detecting at 1010 may be performed by a particular component of the wireless device 350, for example, a component analogous to the WWAN radio 314, the WLAN radio 316, the Bluetooth radio 318, etc. In one possible example, the interference is interference to an existing communication connection associated with a first RAT (e.g., interference to an LTE communication connection is detected using a component analogous to the WWAN radio 314). The wireless device 350 may also generate and/or store data based on the detecting 1010, for example, an amount of interference (or interference level), a time of interference (e.g., the time at which or duration over which the interference was detected), or some other characteristic of the interference (e.g., the radio that detected the interference, the frequency at which the interference was detected, or the RAT or channel associated with the detected interference).

At 1020, the wireless device 350 establishes a wireless D2D communication connection with two or more discovered devices. The establishing at 1020 may be performed by a particular component of the wireless device 350, for example, a component analogous to the coexistence manager 359. For the purpose of illustration, the method 1000 will be described herein as if the wireless devices 360 and 370, respectively, constitute the two or more discovered devices. The wireless D2D communication connection established between the wireless device 350 and the wireless devices 360, 370 may use any suitable technology, including, for example, Long-Term Evolution Direct (LTE-D), AllJoyn, WiFi-Direct, WiFi Aware, Bluetooth, Bluetooth Low Energy (BTLE), etc. In some scenarios, the wireless D2D communication connection may utilize a WLAN access point as a relay device for D2D communications. The establishing at 1020 may be analogous to, for example, the establishing at 630 depicted in FIG. 6. One or more of the other actions depicted may optionally be performed at 1020, including, for example, the device discovery 622, service discovery 624, etc.

At 1030, the wireless device 350 receives cross-device coexistence management data via the wireless D2D communication connection established at 1020. The receiving at 1030 may be performed by a particular component of the wireless device 350, for example, a component analogous to the WWAN radio 314, the WLAN radio 316, the Bluetooth radio 318, etc. The cross-device coexistence management data may include a radio configuration report and may further include a radio change capability report. The cross-device coexistence management data may be received from at least one of the two or more discovered devices. For example, the wireless device 350 may receive a first radio configuration report and/or a first radio change capability report from the wireless device 360. Additionally or alternatively, the wireless device 350 may receive a second radio configuration report and/or a second radio change capability report from the wireless device 370.

The cross-device coexistence management data may be received directly from the wireless device with which the cross-device coexistence management data is associated. Additionally or alternatively, the cross-device coexistence management data may be received from a relay device or intermediary device. For example, the wireless device 360 may receive cross-device coexistence management data from the wireless device 370 and relay the cross-device coexistence management data to the wireless device 350. The wireless device 360 may also generate its own cross-device coexistence management data (for example, a radio configuration report or radio change capability report) and transmit the generated cross-device coexistence management data to the wireless device 350. The cross-device coexistence management data associated with the respective wireless devices 360, 370 may be sent to the wireless device 350 separately or as a cross-device coexistence management data bundle. The cross-device coexistence management data bundle may include the respective cross-device coexistence management data for both wireless devices 360, 370, and also a cross-device coexistence management data label that identifies the wireless device with which the cross-device coexistence management data is associated.

The radio configuration report may include data on the configuration of one or more radios associated with a wireless device. For example, the wireless device 360 may generate and/or store data concerning the power of one or more transmissions, the time (or duration of time) of one or more transmissions, or some other characteristic of the one or more transmissions (e.g., a radio, frequency, RAT, and/or channel used to perform the transmission).

The radio change capability data may include data on the radio changes that a wireless device is willing and/or able to perform. The changes may be changes to the power of one or more transmissions, changes to the time (or duration of time) of one or more transmissions, or changes to some other characteristic of the one or more transmission (e.g., a radio, frequency, RAT, and/or channel used to perform the transmission). The radio change capability data may be implemented using a set of potential radio configurations. For example, the wireless device 360 may be set to transmit at a certain power for a certain period of time, but may be willing and/or able to transmit on any one of three distinct frequencies (frequency #1, frequency #2, frequency #3). Accordingly, the radio change capability data associated with the wireless device 360 may reflect three distinct sets of potential radio configurations.

Each potential radio configuration in the set may additionally include preference data that identifies one or more preferred radio configurations of the set of potential radio configurations. Returning to the earlier example, the wireless device 360 may determine that the potential radio configuration including frequency #1 is preferable to frequency #2 and frequency #3 because it is more efficient, supports a higher data rate, etc. The preference data may include a ranking or a value that reflects the degree of preference of the wireless device 360.

At 1040, the wireless device 350 identifies an aggressor device from among the two or more discovered devices based on the radio configuration report received at 1030. The identifying at 1040 may be performed by a particular component of the wireless device 350, for example, a component analogous to the coexistence manager 359. For example, the wireless device 350 may determine that the wireless device 360 is transmitting at high power on frequency #1 based on the radio configuration report and identify the wireless device 360 as the aggressor device.

The wireless device 350 may also use interference data (i.e., data that is optionally generated and/or stored during the detecting 1010) to identify the aggressor device. For example, the wireless device 350 may detect (at 1010) high levels of interference on frequency #1. If the radio configuration report received from the wireless device 360 indicates that the wireless device 360 is operating at high power on frequency #1, then the wireless device 350 may identify the wireless device 360 as an aggressor device that is causing the interference detected on frequency #1.

At 1050, the wireless device 350 selects a radio change request for the aggressor device. The selecting at 1050 may be performed by a particular component of the wireless device 350, for example, a component analogous to the coexistence manager 359. For example, the wireless device 350 may conclude that interference with a particular communication connection in the communication medium will be reduced if the wireless device 360 operates on frequency #2 or frequency #3. Returning to an earlier example, this conclusion may be based on detection at 1010 of interference on frequency #1 and an identification at 1040 of the wireless device 360 as the cause of the interference detected on frequency #1. Accordingly, the wireless device 350 may select a radio change request for the wireless device 360 that requests that the wireless device 360 operate on frequency #2 or frequency #3.

The wireless device 350 may optionally analyze a radio change capability report received from, for example, the wireless device 360, to determine whether the wireless device 360 is capable of making a radio change that reduces the impact of its operations on the wireless device 350. For example, the wireless device 350 may conclude that interference with a particular communication connection in the communication medium will be reduced if the wireless device 360 operates on frequency #2 or frequency #3, but a radio change capability report received at 1030 may indicate that the wireless device 360 plans to transmit on either frequency #1 or frequency #3. Accordingly, the wireless device 350 may select a radio change request for the wireless device 360 that requests that the wireless device 360 operate on frequency #3.

At 1060, the wireless device 350 transmits the radio change request to the aggressor device via the wireless D2D communication connection. The transmitting at 1060 may be performed by a particular component of the wireless device 350, for example, a component analogous to the WWAN radio 314, the WLAN radio 316, the Bluetooth radio 318, etc.

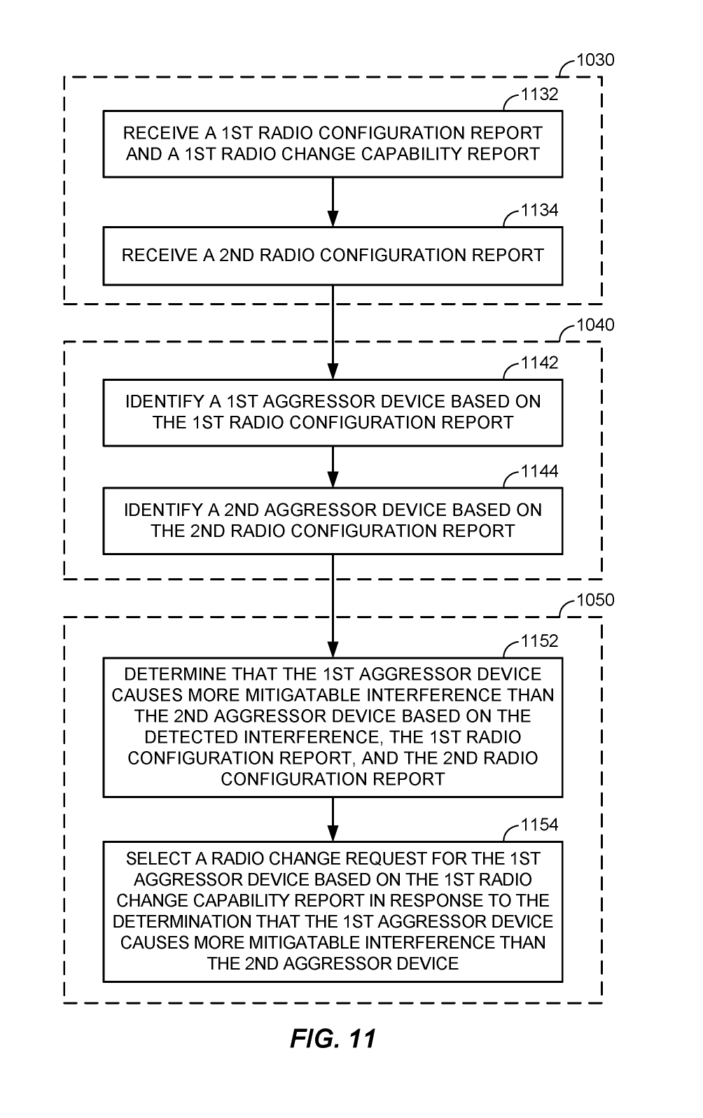

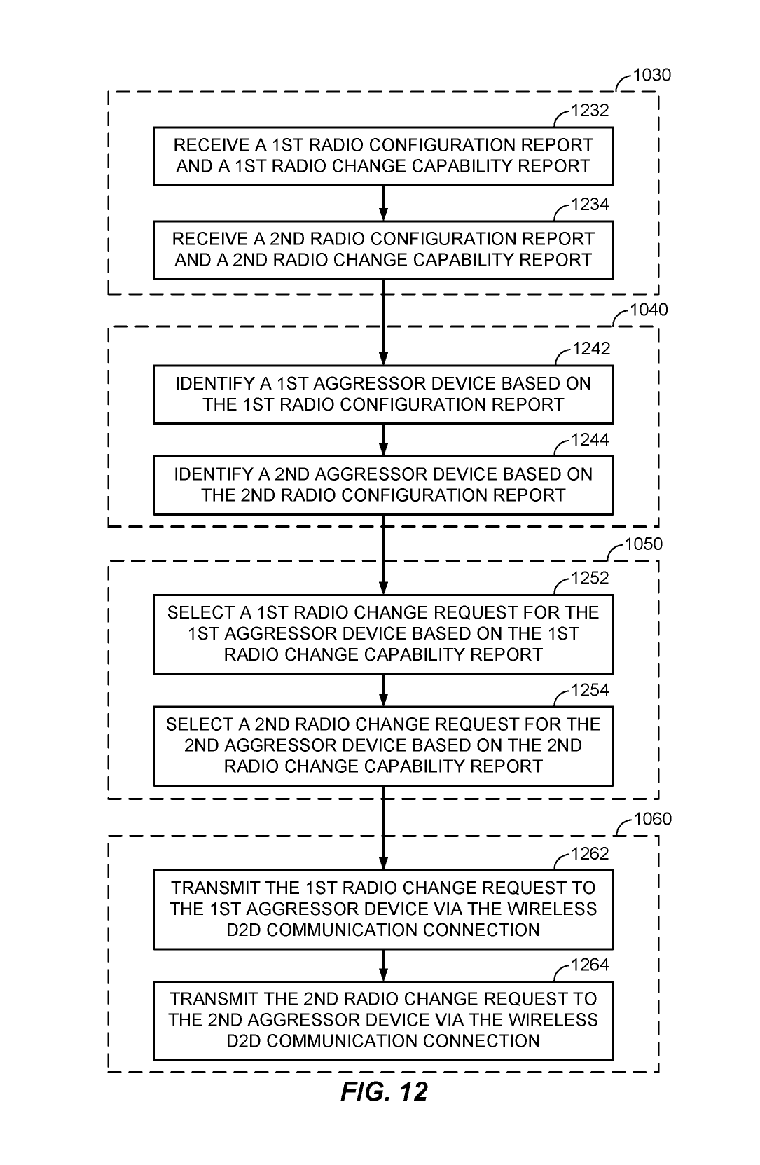

Returning to FIG. 3B, it will be appreciated that the wireless device 350 may be a victim device in a multi-aggressor scenario (in which the wireless devices 360 and 370 are aggressor devices). As will be discussed in greater detail below, there are a variety of suitable techniques for mitigating interference in a multi-aggressor scenario, two of which are depicted in FIGS. 11-12. FIG. 11 is concerned with ‘prioritized’ interference mitigation, in which a radio change request is sent to the aggressor device that is causing the most mitigatable interference. FIG. 12 is concerned with ‘parallel’ interference mitigation, in which multiple radio change requests are sent to multiple aggressor devices.

FIG. 11 illustrates in more detail an example implementation of certain aspects of the method 1000 of FIG. 10. In this implementation, more specific operations are shown for the receiving at 1030, identifying at 1040, and selecting at 1050. For the purposes of illustration, the method of FIG. 11 will be described below as it would be performed by the wireless device 350, however, it will be appreciated that other devices may perform the methods described herein.

As noted above in the foregoing description of FIG. 10, the wireless device 350 receives at 1030 cross-device coexistence management data via the wireless D2D communication connection established at 1020. More specific operations for the receiving (labeled in FIG. 11 as 1132 and 1134) are described below.

At 1132, the wireless device 350 receives a first radio configuration report. The wireless device 350 may also receive at 1132 a first radio change capability report. At 1134, the wireless device 350 receives a second radio configuration report. The wireless device 350 may also receive at 1134 a second radio change capability report. In an example, the wireless device 350 receives the first radio configuration report and the first radio change capability report from the wireless device 360 and receives the second radio configuration report from the wireless device 370.

As noted above in the foregoing description of FIG. 10, the wireless device 350 identifies at 1040 an aggressor device from among the two or more discovered devices based on the received radio configuration report. More specific operations for the identifying at 1040 (labeled in FIG. 11 as 1142 and 1144) are described below.

At 1142, the wireless device 350 identifies a first aggressor device based on the first radio configuration report. At 1144, the wireless device 350 identifies a second aggressor device based on the second radio configuration report. Returning to the previous example, the wireless device 350 may determine based on the first radio configuration report that the wireless device 360 is an aggressor device (i.e., the first aggressor device). The wireless device 350 may further determine based on the second radio configuration report that the wireless device 370 is also an aggressor device (i.e., the second aggressor device).

As noted above in the foregoing description of FIG. 10, the wireless device 350 selects at 1050 a radio change request for the aggressor device. More specific operations for the selecting at 1050 (labeled in FIG. 11 as 1152 and 1154) are described below.

At 1152, the wireless device 350 determines that the first aggressor device causes more mitigatable interference than the second aggressor device. The determination at 1152 may be based on one or more of the detected interference (detected at 1010), the first radio configuration report (received at 1132), and the second radio configuration report (received at 1134). For example, a scenario might arise in which the wireless device 350 detects a high level of interference on frequency #1. The first radio configuration report may indicate that the wireless device 360 is transmitting with high transmission power on frequency #1, and the second configuration report may indicate that the wireless device 370 is transmitting with low transmission power on frequency #1. Accordingly, the wireless device 350 may determine that the wireless device 360 is causing more mitigatable interference than the wireless device 370.

At 1154, the wireless device 350 selects a radio change request for the first aggressor device. The selecting at 1154 may be based on a first radio change capability report received at 1132. The selecting at 1154 may also be responsive to the determination at 1152 that the first aggressor device causes more mitigatable interference than the second aggressor device. Returning to the earlier example, the wireless device 350 may select a radio change request for the wireless device 360 based on a determination at 1154 that the wireless device 360 causes more mitigatable interference than the wireless device 370.

FIG. 12 illustrates in more detail an example implementation of certain aspects of the method 1000 of FIG. 10. In this implementation, more specific operations are shown for the receiving at 1030, identifying at 1040, selecting at 1050, and transmitting at 1060. For the purposes of illustration, the method of FIG. 12 will be described below as it would be performed by the wireless device 350, however, it will be appreciated that other devices may perform the methods described herein.

As noted above in the foregoing description of FIG. 10, the wireless device 350 receives at 1030 cross-device coexistence management data via the wireless D2D communication connection established at 1020. More specific operations for the receiving (labeled in FIG. 12 as 1232 and 1234) are described below.

At 1232, the wireless device 350 receives a first radio configuration report. The wireless device 350 may also receive at 1232 a first radio change capability report. At 1234, the wireless device 350 receives a second radio configuration report. The wireless device 350 may also receive at 1234 a second radio change capability report. In an example, the wireless device 350 receives the first radio configuration report and the first radio change capability report from the wireless device 360 and receives the second radio configuration report and the second radio change capability report from the wireless device 370.

As noted above in the foregoing description of FIG. 10, the wireless device 350 identifies at 1040 an aggressor device from among the two or more discovered devices based on the received radio configuration report. More specific operations for the identifying at 1040 (labeled in FIG. 12 as 1242 and 1244) are described below.

At 1242, the wireless device 350 identifies a first aggressor device based on the first radio configuration report. At 1244, the wireless device 350 identifies a second aggressor device based on the second radio configuration report. Returning to the previous example, the wireless device 350 may determine based on the first radio configuration report that the wireless device 360 is an aggressor device (i.e., the first aggressor device). The wireless device 350 may further determine based on the second radio configuration report that the wireless device 370 is also an aggressor device (i.e., the second aggressor device).

As noted above in the foregoing description of FIG. 10, the wireless device 350 selects at 1050 a radio change request for the aggressor device. More specific operations for the selecting at 1050 (labeled in FIG. 12 as 1252 and 1254) are described below.

At 1252, the wireless device 350 selects a first radio change request for the first aggressor device based on the first radio change capability report. At 1254, the wireless device 350 selects a second radio change request for the second aggressor device based on the second radio change capability report. For example, a scenario might arise in which the wireless device 350 detects a high level of interference on frequency #1. The first radio configuration report may indicate that the wireless device 360 is transmitting on frequency #1, and the second radio configuration report may indicate that the wireless device 370 is transmitting on frequency #1. Accordingly, the wireless device 350 may select a first radio change request that requests the wireless device 360 to transmit on frequency #2 or frequency #3. The wireless device 350 may further select a second radio change request that requests the wireless device 370 to transmit on frequency #2 or frequency #3.

As noted above in the foregoing description of FIG. 10, the wireless device 350 transmits at 1060 the radio change request to the aggressor device via the wireless D2D communication connection. More specific operations for the transmission at 1060 (labeled in FIG. 12 as 1262 and 1264) are described below.

At 1262, the wireless device 350 transmits the first radio change request to the first aggressor device via the wireless D2D communication connection. At 1264, the wireless device 350 transmits the second radio change request to the second aggressor device via the wireless D2D communication connection.

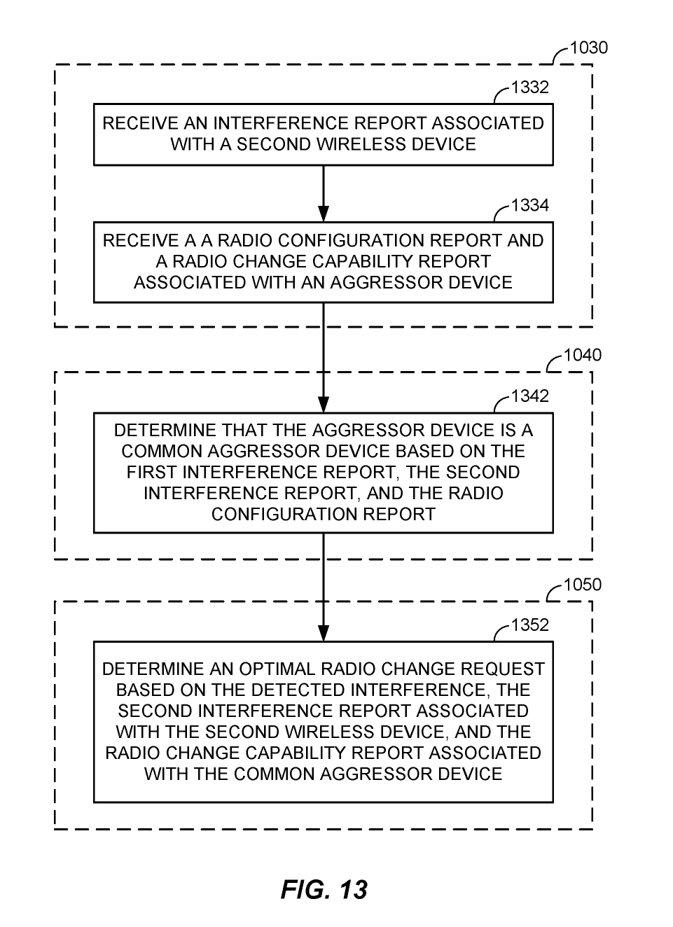

Returning to FIG. 3B, it will be appreciated that wireless device 350 may be a victim device in a multi-victim scenario. In a multi-victim scenario, a common aggressor device (for example, the wireless device 370) may cause interference that is detected by a plurality of victim devices (for example, the wireless devices 350, 360). As will be discussed in greater detail below, there are a variety of suitable techniques for mitigating interference in a multi-aggressor scenario. FIG. 13 is concerned with ‘coordinated’ interference mitigation, in which multiple victims coordinate with one another to select and transmit an optimal radio change request to a common aggressor device.

FIG. 13 illustrates in more detail an example implementation of certain aspects of the method 1000 of FIG. 10. In this implementation, more specific operations are shown for the receiving at 1030, identifying at 1040, and selecting at 1050. For the purposes of illustration, the method of FIG. 13 will be described below as it would be performed by the wireless device 350, however, it will be appreciated that other devices may perform the methods described herein.

As noted above in the foregoing description of FIG. 10, the wireless device 350 receives at 1030 cross-device coexistence management data via the wireless D2D communication connection established at 1020. More specific operations for the receiving (labeled in FIG. 13 as 1332 and 1334) are described below.

At 1332, the wireless device 350 receives an interference report associated with a second wireless device. At 1334, the wireless device 350 receives a radio configuration report and a radio change capability report associated with an aggressor device. For example, the wireless device 350 may further receive an interference report from the wireless device 360 (another victim device in this scenario) and a radio configuration report from the wireless device 370 (a common aggressor device in this scenario).

As noted above in the foregoing description of FIG. 10, the wireless device 350 identifies at 1040 an aggressor device from among the two or more discovered devices based on the received radio configuration report. More specific operations for the identifying at 1040 (labeled in FIG. 13 as 1342) are described below.

At 1342, the wireless device 350 determines that the aggressor device is a common aggressor device based on the first interference report, the second interference report, and the radio configuration report. For example, the wireless device 350 may have detected (at 1010) interference on frequency #1. The interference report received at 1332 from the wireless device 360 may indicate that the wireless device 360 is detecting interference on frequency #1 and frequency #2. Because both the wireless device 350 and the wireless device 360 are experiencing interference on a common frequency (frequency #1), the wireless device 350 may conclude that they are victims of a common aggressor device.

Moreover, the radio configuration report received at 1334 from the wireless device 370 may indicate that the wireless device 370 is operating on frequency #1 and frequency #2. On this basis, the wireless device 350 may conclude that the wireless device 370 is the common aggressor device that is causing interference to both the wireless device 350 and the wireless device 360 on frequency #1.

As noted above in the foregoing description of FIG. 10, the wireless device 350 selects at 1050 a radio change request for the aggressor device. More specific operations for the selecting at 1050 (labeled in FIG. 13 as 1352) are described below.

At 1352, the wireless device 350 determines an optimal radio change request based on the detected interference, the interference report associated with the second wireless device, and the radio change capability report associated with the common aggressor device. For example, the radio change capability report received from the wireless device 370 may indicate that the wireless device 370 is willing and able to reduce transmit power on either frequency #1 or frequency #2. The wireless device 350 may determine that a reduction of transmission power on either frequency will reduce interference at the wireless device 350 to the same degree. However, the wireless device 350 may determine that a reduction in transmission power on frequency #1 will have a positive mitigation impact on the wireless device 360, while a reduction in transmission power on frequency #2 will have no mitigation impact on the wireless device 360. Accordingly, the optimal radio change request will be for the wireless device 370 to reduce transmission power on frequency #1.

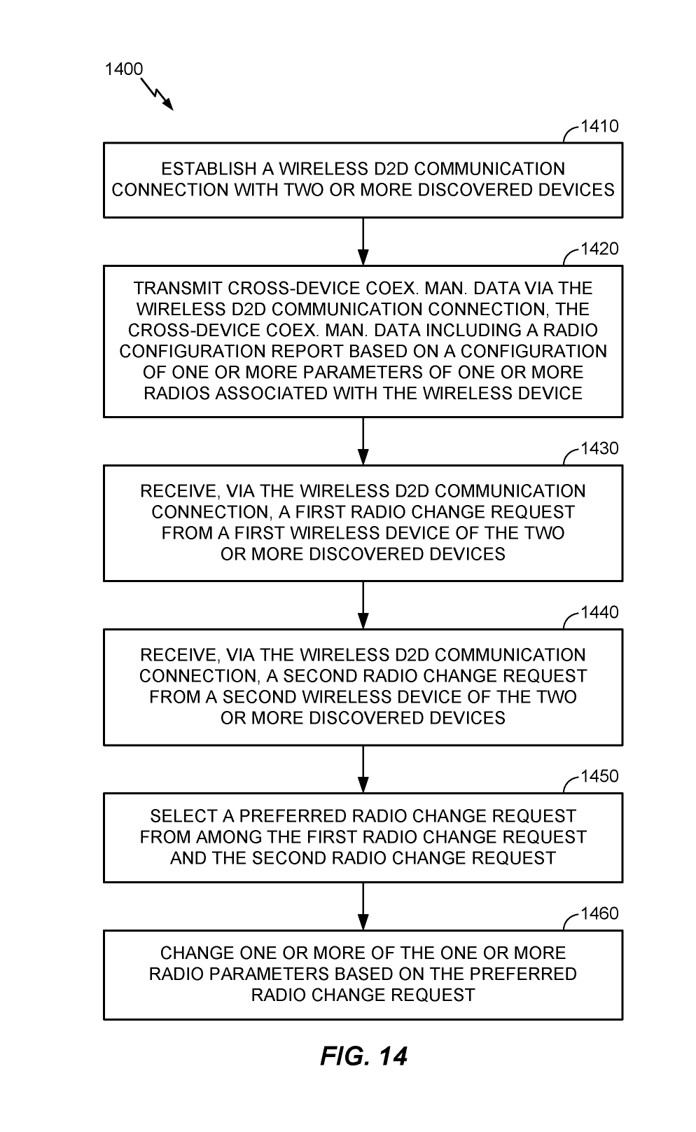

FIG. 14 generally illustrates another method 1400 for improving coexistence among three or more wireless devices. The method 1400 may be performed by, for example, a wireless device analogous to the wireless devices 310, 320, 350, 360, 370, 400A, 400B, 500, etc. However, for the purpose of illustration, the method 1400 will be described herein as it would be performed by the wireless device 350.

At 1410, the wireless device 350 establishes a wireless D2D communication connection with two or more discovered devices. The establishing at 1410 may be similar to the establishing at 1020 described elsewhere in the disclosure. For brevity, further description of the establishing at 1410 will be omitted here.

At 1420, the wireless device 350 transmits cross-device coexistence management data via the wireless D2D communication connection established at 1410. The cross-device coexistence management data may include a radio configuration report based on a configuration of one or more parameters of one or more radios associated with the wireless device. The transmitting at 1420 may be performed by a particular component of the wireless device 350, for example, a component analogous to the WWAN radio 314, the WLAN radio 316, the Bluetooth radio 318, etc. As noted above, a radio configuration report may include data on the configuration of one or more radios associated with a wireless device. For example, the wireless device 350 may generate and/or store data concerning the power of one or more transmissions, the time (or duration of time) of one or more transmissions, or some other characteristic of the one or more transmissions (e.g., a radio, frequency, RAT, and/or channel used to perform the transmission).

The cross-device coexistence management data transmitted at 1420 may also include radio change capability data. The radio change capability data may include data on the radio changes that a wireless device is willing and/or able to perform. The changes may be changes to the power of one or more transmissions, the time (or duration of time) of one or more transmissions, or some other characteristic of the one or more transmission (e.g., a radio, frequency, RAT, and/or channel used to perform the transmission). The radio change capability data may be implemented using a set of potential radio configurations.

The transmitting at 1420 may be responsive to a request for cross-device coexistence management data (not shown). For example, a second wireless device may detect interference, establish a D2D communication connection with the wireless device 350, and then transmit a cross-device coexistence management data request. The cross-device coexistence management data request may include a radio configuration data request and/or a radio change capability request. The cross-device coexistence management data request may include a request for all radio configuration data or for radio configuration data that is specific to one or more RATs, channels, and/or frequencies.

At 1430, the wireless device 350 receives, via the wireless D2D communication connection established at 1410, a first radio change request from a first wireless device of the two or more discovered devices. At 1440, the wireless device 350 receives, via the wireless D2D communication connection established at 1410, a second radio change request from a second wireless device of the two or more discovered devices. The receiving at 1430 and the receiving at 1440 may be performed by a particular component of the wireless device 350, for example, a component analogous to the WWAN radio 314, the WLAN radio 316, the Bluetooth radio 318, etc. For example, the first radio change request may be a request from the wireless device 360 that the wireless device 350 cease operating on frequency #1 and begin operating on frequency #2. Moreover, the second radio change request may be a request from the wireless device 370 that the wireless device 350 cease operating on frequency #1 and begin operating on frequency #3.

At 1450, the wireless device 350 selects a preferred radio change request from among the first radio change request received at 1430 and the second radio change request received at 1440. The selecting at 1450 may be performed by a particular component of the wireless device 350, for example, a component analogous to the coexistence manager 359. A preferred radio change may be a change that has the least negative impact on the efficiency of the wireless device 350. Alternatively or additionally, the preferred radio change may be a change that has the least negative impact on the efficiency of the network or another wireless device.

In one implementation of the selecting at 1450, the wireless device 350 may calculate a first impact of selecting the first radio change request on the efficiency of the wireless device, calculate a second impact of selecting the second radio change request on the efficiency of the wireless device, determining which of the first impact and second impact is greater, and select the radio change request with the lesser impact on the efficiency of the wireless device. For example, the wireless device 350 may calculate that the selection of the first radio change request will result in a radio change having a minor negative impact on power usage, data rate, or interference with some other wireless device. Moreover, the wireless device 350 may calculate that the selection of the second radio change request will result in a radio change having a major negative impact on power usage, data rate, or interference with some other wireless device. Accordingly, the first radio change request may be selected as the preferred radio change request.

Optionally at 1450, the wireless device 350 may first determine whether the first radio change request received at 1430 and the second radio change request received at 1440 can both be performed. For example, the wireless device 350 may determine whether the first and second radio change request can both be granted. If both requests can be granted, then the wireless device 350 may change one or more of the one or more parameters based on the first radio change request received at 1430 and the second radio change request received at 1440. Conversely, if the first and second radio change requests include contradictory instructions (for example, a first radio change request to change a transmission frequency from #1 to frequency #2 and a second radio change request to reduce transmission power on frequency #2), then the wireless device 350 may proceed to select a preferred radio change request.

The determination as to whether both requests can be granted may be a conditional determination in which the wireless device 350 determines whether both requests can be granted without too great a negative impact on power usage of the wireless device 350, data rate of the wireless device 350, or interference of the wireless device 350 with some other wireless device. For example, if the wireless device 350 determines that both the first and second radio change requests could be granted, but that the negative impact on the performance or efficiency of the wireless device 350 or the surrounding wireless environment would exceed a negative impact threshold, then the wireless device 350 may proceed to select a preferred radio change request.

At 1460, the wireless device 350 changes one or more of the one or more radio parameters based on the preferred radio change. The changing at 1460 and the receiving at 1440 may be performed by a particular component of the wireless device 350, for example, a component analogous to the WWAN radio 314, the WLAN radio 316, the Bluetooth radio 318, etc. Alternatively or additionally, the changing at 1460 may be performed by a particular component of the wireless device 350, for example, a component analogous to the coexistence manager 359. For example, in response to a selection at 1450 of the first radio change request as the preferred radio change request, the wireless device 350 may make one or more of the changes identified in the first radio change request, i.e., the wireless device 350 may cease operating on frequency #1 and begin operating on frequency #2.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for improving coexistence among wireless devices, comprising:
detecting, at a first wireless device, interference on a first radio access technology (RAT) channel;
initiating, by the first wireless device, a discovery protocol to identify a proximate wireless device in response to the detecting;
establishing, by the first wireless device, a wireless communication connection with the proximate wireless device;
requesting, by the first wireless device, radio configuration information and radio change capability information from the proximate wireless device via the wireless communication connection;
receiving, at the first wireless device, the radio configuration information and the radio change capability information from the proximate wireless device via the wireless communication connection; and
attempting, by the first wireless device, to mitigate interference based on the radio configuration information and the radio change capability information received from the proximate wireless device.

2. The method of claim 1, further comprising establishing a first RAT communication connection on the first RAT channel, wherein the detecting of the interference on the first RAT channel includes detecting interference to the first RAT communication connection.

3. The method of claim 1, wherein the attempting comprises:
determining that the proximate wireless device is an interfering wireless device based on the detected interference and the received radio configuration information.

4. The method of claim 3, wherein the attempting further comprises generating a radio reconfiguration request in response to a determination that the proximate wireless device is the interfering wireless device.

5. The method of claim 4, wherein generating the radio reconfiguration request comprises:
identifying one or more radio changes that reduce interference of the interfering wireless device based on the detected interference and the received radio configuration information;
comparing the one or more identified radio changes to the radio change capability information received from the interfering wireless device;
selecting at least one of the one or more identified radio changes in response to a positive comparison between the one or more identified radio changes to the radio change capability information; and
including the selected radio changes in the radio reconfiguration request.

6. The method of claim 5, wherein identifying the one or more radio changes that reduce interference comprises retrieving radio change information from a lookup table that relates the detected interference and the received radio configuration information to a set of one or more radio changes that reduce interference.

7. The method of claim 4, wherein the attempting further comprises transmitting the radio reconfiguration request to the interfering wireless device.

8. The method of claim 3, wherein the determining that the proximate wireless device is the interfering wireless device is based on one or more characteristics of the detected interference, one or more characteristics of operations of the proximate wireless device indicated by the radio configuration information, a location of the proximate wireless device, or a combination thereof.

9. The method of claim 1, wherein the detecting comprises detecting a received signal strength indicator (RSSI) above a threshold or detecting an interfering jammer device.

10. The method of claim 1, wherein the discovery protocol comprises an LTE-D discovery protocol, a WiFi-Direct discovery protocol, a WiFi Aware discovery protocol, an AllJoyn discovery protocol, a Bluetooth discovery protocol, or a Bluetooth Low Energy (BTLE) discovery protocol.

11. The method of claim 1, wherein the establishing comprises establishing the wireless communication connection over LTE-D, WiFi-Direct, WiFi Aware, AllJoyn, Bluetooth, Bluetooth Low Energy (BTLE), or a WLAN access point.

12. An apparatus for improving coexistence among wireless devices, comprising:
a plurality of transceivers, each of the plurality of transceivers configured to establish a communication connection;
a coexistence manager configured to:
detect interference on a first radio access technology (RAT) channel;
initiate a discovery protocol to identify a proximate wireless device in response to the detecting;
establish, via at least one of the plurality of transceivers, a wireless communication connection with the proximate wireless device;
request, via the at least one of the plurality of transceivers, radio configuration information and radio change capability information from the proximate wireless device;
receive, via the at least one of the plurality of transceivers, the radio configuration information and the radio change capability information from the proximate wireless device via the wireless communication connection; and
attempt to mitigate interference based on the radio configuration information and the radio change capability information received from the proximate wireless device.

13. The apparatus of claim 12, wherein at least one of the plurality of transceivers is configured to establish a first RAT communication connection on the first RAT channel, and the coexistence manager is further configured to detect interference on the first RAT channel by detecting interference to the first RAT communication connection.

14. The apparatus of claim 12, wherein the coexistence manager is further configured to determine that the proximate wireless device is an interfering wireless device based on the detected interference and the received radio configuration information.

15. The apparatus of claim 14, wherein the coexistence manager is further configured to generate a radio reconfiguration request in response to a determination that the proximate wireless device is the interfering wireless device.

16. The apparatus of claim 15, wherein the coexistence manager is further configured to:
identify one or more radio changes that reduce interference of the interfering wireless device based on the detected interference and the received radio configuration information;
compare the one or more identified radio changes to the radio change capability information received from the interfering wireless device;
select at least one of the one or more identified radio changes in response to a positive comparison between the one or more identified radio changes to the radio change capability information; and
include the selected radio changes in the radio reconfiguration request.

17. The apparatus of claim 16, wherein the coexistence manager is further configured to retrieve radio change information from a lookup table that relates the detected interference and the received radio configuration information to a set of one or more radio changes that reduce interference.

18. The apparatus of claim 15, wherein the coexistence manager is further configured to transmit the radio reconfiguration request to the interfering wireless device.

19. The apparatus of claim 14, wherein the coexistence manager is further configured to determine that the proximate wireless device is the interfering wireless device based on one or more characteristics of the detected interference, one or more characteristics of operations of the proximate wireless device indicated by the radio configuration information, a location of the proximate wireless device, or a combination thereof.

20. The apparatus of claim 12, wherein the coexistence manager is further configured to detect interference by determining whether a received signal strength indicator (RSSI) is above a threshold or by detecting an interfering jammer device.

21. The apparatus of claim 12, wherein the discovery protocol comprises an LTE-D discovery protocol, a WiFi-Direct discovery protocol, a WiFi Aware discovery protocol, an AllJoyn discovery protocol, a Bluetooth discover protocol, or a Bluetooth Low Energy (BTLE) discovery protocol.

22. The apparatus of claim 12, wherein the wireless communication connection comprises an LTE-D connection, a WiFi-Direct connection, a WiFi Aware connection, an AllJoyn connection, a Bluetooth connection, a Bluetooth Low Energy (BTLE) connection, or a WLAN access point connection.

23. A method for improving coexistence among wireless devices, comprising:
discovering, by a first wireless device, a proximate wireless device;
establishing, by the first wireless device, a wireless communication connection with the proximate wireless device;
receiving, from the proximate wireless device via the wireless communication connection, a request for radio configuration information and radio change capability information;
determining, by the first wireless device, radio configuration information and radio change capability information relating to radio operations of the first wireless device; and
transmitting the radio configuration information and the radio change capability information to the proximate wireless device.

24. The method of claim 23, further comprising:
receiving, from the proximate wireless device via the wireless communication connection, a radio reconfiguration request; and
reconfiguring the radio operations of the first wireless device based on the radio reconfiguration request.

25. The method of claim 24, wherein the reconfiguring comprises ceasing radio operations associated with a particular radio access technology (RAT) or frequency, reducing transmit power associated with a particular RAT or frequency, or adjusting timing of operations associated with a particular RAT or frequency.

26. The method of claim 24, further comprising transmitting, to the proximate wireless device via the wireless communication connection, a radio reconfiguration notification.

27. The method of claim 23, further comprising:
receiving, from the proximate wireless device, interference information relating to interference detected at the proximate wireless device; and
attempting to mitigate interference based on the determined radio configuration information and the radio change capability information and the interference information received from the proximate wireless device.

28. The method of claim 27, wherein the attempting comprises:
determining, by the first wireless device, whether the first wireless device is an interfering wireless device based on the received interference information and the determined radio configuration information;
selecting, by the first wireless device, a radio change in response to a determination that the first wireless device is the interfering wireless device;
comparing, by the first wireless device, the selected radio change to the determined radio change capability information; and
reconfiguring radio operations of the first wireless device based on the selected radio change in response to a positive comparison between the selected radio change and the radio change capability information determined by the first wireless device.

29. The method of claim 28, wherein the determining whether the first wireless device is an interfering wireless device is based on one or more characteristics of the received interference information, one or more characteristics of the radio configuration information, a location of the proximate wireless device, or a combination thereof.

30. The method of claim 24, wherein the radio change capability information includes information on which radio access technologies (RATs) are presently available for operations, information on which frequencies, timings, and/or channels within a given RAT are presently available for operations, information on what transmission power associated with a given RAT, frequencies, timings, or channels is presently available for operations, or a combination thereof.

31. The method of claim 23, wherein the discovering of the proximate wireless device includes discovering in accordance with a discovery protocol, wherein the discovery protocol comprises an LTE-D discovery protocol, a WiFi-Direct discovery protocol, an AllJoyn discovery protocol, a WiFi Aware discovery protocol, or a Bluetooth Low Energy (BTLE) discovery protocol.

32. The method of claim 23, wherein the establishing comprises establishing the wireless communication connection over LTE-D, WiFi-Direct, Bluetooth Low Energy (BTLE), or a WLAN access point.

33. An apparatus for improving coexistence among wireless devices, comprising:
a plurality of transceivers associated with a first wireless device, each of the plurality of transceivers configured to establish a communication connection; and
a coexistence manager configured to:
discover a proximate wireless device;
establish a wireless communication connection with the proximate wireless device;
receive, from the proximate wireless device via the wireless communication connection, a request for radio configuration information and radio change capability information;
determine radio configuration information and radio change capability information relating to radio operations of the first wireless device; and
transmit the radio configuration information and the radio change capability information to the proximate wireless device.

34. The apparatus of claim 33, wherein the coexistence manager is further configured to:
receive, from the proximate wireless device via the wireless communication connection, a radio reconfiguration request; and
reconfigure the radio operations of the first wireless device based on the radio reconfiguration request.

35. The apparatus of claim 34, wherein the coexistence manager is further configured to cease radio operations associated with a particular radio access technology (RAT) or frequency, reduce transmit power associated with a particular RAT or frequency, or adjust timing of operations associated with a particular RAT or frequency.

36. The apparatus of claim 34, wherein the coexistence manager is further configured to transmit, to the proximate wireless device via the wireless communication connection, a radio reconfiguration notification.

37. The apparatus of claim 33, wherein the coexistence manager is further configured to:
receive, from the proximate wireless device, interference information relating to interference detected at the proximate wireless device; and
attempt to mitigate interference based on the determined radio configuration information and the radio change capability information and the interference information received from the proximate wireless device.

38. The apparatus of claim 37, wherein the coexistence manager is further configured to:
determine whether the first wireless device is an interfering wireless device based on the received interference information and the determined radio configuration information;
select a radio change for the first wireless device in response to a determination that the first wireless device is the interfering wireless device;
comparing the selected radio change to the determined radio change capability information; and
reconfiguring radio operations of the first wireless device based on the selected radio change in response to a positive comparison between the selected radio change and the radio change capability information determined by the first wireless device.

39. The apparatus of claim 38, wherein the coexistence manager is further configured to determine whether the first wireless device is an interfering wireless device based on one or more characteristics of the received interference information, one or more characteristics of the radio configuration information, a location of the proximate wireless device, or a combination thereof.

40. The apparatus of claim 34, wherein the radio change capability information includes information on which radio access technologies (RATs) are presently available for operations, information on which frequencies, timings, and/or channels within a given RAT are presently available for operations, information on what transmission power associated with a given RAT, frequencies, timings, or channels is presently available for operations, or a combination thereof.

41. The apparatus of claim 33, wherein to discover the proximate wireless device, the coexistence manager performs discovery in accordance with a discovery protocol, wherein the discovery protocol comprises an LTE-D discovery protocol, a WiFi-Direct discovery protocol, an AllJoyn discovery protocol, a WiFi Aware discovery protocol, or a Bluetooth Low Energy (BTLE) discovery protocol.

42. The apparatus of claim 33, wherein the establishing comprises establishing the communication connection over LTE-D, WiFi-Direct, Bluetooth Low Energy (BTLE), or a WLAN access point.

43. A communication apparatus, comprising:
one or more transceivers configured to:
detect, at a wireless device, interference in a communication medium;
establish a wireless device-to-device (D2D) communication connection with two or more discovered devices;
receive cross-device coexistence management data via the wireless D2D communication connection, wherein the cross-device coexistence management data includes a radio configuration report from at least one of the two or more discovered devices; and
transmit a radio change request to an aggressor device via the wireless D2D communication connection; and
a processor configured to:
identify the aggressor device from among the two or more discovered devices based on the radio configuration report; and
select the radio change request for the aggressor device; and
memory coupled to the processor and configured to store data, instructions, or a combination thereof.

44. The communication apparatus of claim 43, wherein:
the one or more transceivers are further configured to:
receive a first radio configuration report and a first radio change capability report; and
receive a second radio configuration report; and
the processor is further configured to:
identify a first aggressor device based on the first radio configuration report; and
identify a second aggressor device based on the second radio configuration report.

45. The communication apparatus of claim 44, wherein the processor is further configured to:
determine that the first aggressor device causes more mitigatable interference than the second aggressor device based on the detected interference, the first radio configuration report, and the second radio configuration report.

46. The communication apparatus of claim 45, wherein to select the radio change request for the aggressor device, the processor is further configured to:
select a radio change request for the first aggressor device based on the first radio change capability report in response to the determination that the first aggressor device causes more mitigatable interference than the second aggressor device.

47. The communication apparatus of claim 43, wherein:
the one or more transceivers are further configured to:
receive a first radio configuration report and a first radio change capability report; and
receive a second radio configuration report and a second radio change capability report; and
the processor is further configured to:
identify a first aggressor device based on the first radio configuration report; and
identify a second aggressor device based on the second radio configuration report.

48. The communication apparatus of claim 47, wherein:
to select the radio change request for the aggressor device, the processor is further configured to:
select a first radio change request for the first aggressor device based on the first radio change capability report; and
select a second radio change request for the second aggressor device based on the second radio change capability report; and
to transmit the radio change request to the aggressor device, the processor is further configured to:
transmit the first radio change request to the first aggressor device via the wireless D2D communication connection; and
transmit the second radio change request to the second aggressor device via the wireless D2D communication connection.

49. The communication apparatus of claim 43, wherein:
the one or more transceivers are further configured to:
receive a second interference report associated with a second wireless device; and
receive a radio configuration report and a radio change capability report associated with an aggressor device; and
to identify the aggressor device, the processor is further configured to determine that the aggressor device is a common aggressor device based on the detected interference, the second interference report, and the radio configuration report.

50. The communication apparatus of claim 49, wherein to select the radio change request for the aggressor device, the processor is further configured to:
determine an optimal radio change request based on the detected interference, the interference report associated with the second wireless device, and the radio change capability report associated with the common aggressor device.

51. The communication apparatus of claim 43, wherein the wireless D2D communication connection comprises one or more of Long-Term Evolution Direct, AllJoyn, WiFi-Direct, WiFi Aware, Bluetooth, or Bluetooth Low Energy (BTLE).

52. The communication apparatus of claim 43, wherein:
to identify the aggressor device, the processor is further configured to identify the aggressor device from among the two or more discovered devices based on the radio configuration report and the detected interference; and
to select the radio change request for the aggressor device, the processor is further configured to select the radio change request for the aggressor device based on a radio change capability report and the detected interference.

53. A communication method for improving coexistence, comprising:
detecting, at a wireless device, interference in a communication medium;
establishing a wireless device-to-device (D2D) communication connection with two or more discovered devices;
receiving cross-device coexistence management data via the wireless D2D communication connection, wherein the cross-device coexistence management data includes a radio configuration report from at least one of the two or more discovered devices;
identifying an aggressor device from among the two or more discovered devices based on the radio configuration report;
selecting a radio change request for the aggressor device;
transmitting the radio change request to the aggressor device via the wireless D2D communication connection.

54. The communication method of claim 53, wherein:
receiving the cross-device coexistence management data comprises:
receiving a first radio configuration report and a first radio change capability report; and
receiving a second radio configuration report; and
identifying the aggressor device comprises:
identifying a first aggressor device based on the first radio configuration report; and
identifying a second aggressor device based on the second radio configuration report.

55. The communication method of claim 54, further comprising:
determining that the first aggressor device causes more mitigatable interference than the second aggressor device based on the detected interference, the first radio configuration report, and the second radio configuration report.

56. The communication method of claim 55, wherein the selecting of the radio change request for the aggressor device comprises:
selecting a radio change request for the first aggressor device based on the first radio change capability report in response to the determination that the first aggressor device causes more mitigatable interference than the second aggressor device.

57. The communication method of claim 53, wherein:
receiving the cross-device coexistence management data comprises:
receiving a first radio configuration report and a first radio change capability report; and
receiving a second radio configuration report and a second radio change capability report; and
identifying an aggressor device comprises:
identifying a first aggressor device based on the first radio configuration report; and
identifying a second aggressor device based on the second radio configuration report.

58. The communication method of claim 57, wherein:
selecting the radio change request for the aggressor device comprises:
selecting a first radio change request for the first aggressor device based on the first radio change capability report; and
selecting a second radio change request for the second aggressor device based on the second radio change capability report; and
transmitting the radio change request to the aggressor device via the wireless D2D communication connection comprises:
transmitting the first radio change request to the first aggressor device via the wireless D2D communication connection; and
transmitting the second radio change request to the second aggressor device via the wireless D2D communication connection.

59. The communication method of claim 53, wherein:
receiving the cross-device coexistence management data comprises:
receiving a second interference report associated with a second wireless device; and
receiving a radio configuration report and a radio change capability report associated with an aggressor device; and
identifying the aggressor device comprises determining that the aggressor device is a common aggressor device based on the detected interference, the second interference report, and the radio configuration report.

60. The communication method of claim 59, wherein the selecting of the radio change request for the aggressor device comprises:
determining an optimal radio change request based on the detected interference, the second interference report, and the radio change capability report associated with the common aggressor device.

61. The communication method of claim 53, wherein the wireless D2D communication connection comprises one or more of Long-Term Evolution Direct, AllJoyn, WiFi-Direct, WiFi Aware, Bluetooth, or Bluetooth Low Energy (BTLE).

62. The communication method of claim 53, wherein:
identifying the aggressor device from among the two or more discovered devices based on the radio configuration report comprises identifying the aggressor device from among the two or more discovered devices based on the radio configuration report and the detected interference; and
selecting the radio change request for the aggressor device based on a radio change capability report comprises selecting the radio change request for the aggressor device based on the radio change capability report and the detected interference.

63. A communication apparatus for improving coexistence, comprising:
one or more transceivers configured to:
establish, from a wireless device, a wireless device-to-device (D2D) communication connection with two or more discovered devices;
transmit cross-device coexistence management data via the wireless D2D communication connection, the cross-device coexistence management data including a radio configuration report based on a configuration of one or more radio parameters of one or more radios associated with the wireless device
receive, via the wireless D2D communication connection, a first radio change request from a first wireless device of the two or more discovered devices; and
receive, via the wireless D2D communication connection, a second radio change request from a second wireless device of the two or more discovered devices;
a processor configured to:
select a preferred radio change request from among the first radio change request and the second radio change request; and
change one or more of the one or more radio parameters based on the preferred radio change request; and
memory coupled to the processor and configured to store data, instructions, or a combination thereof.

64. The communication apparatus of claim 63, wherein the cross-device coexistence management data further includes a radio change capability report based on a radio change capability of the one or more parameters of the one or more radios associated with the wireless device.

65. The communication apparatus of claim 63, wherein to select the preferred radio change request, the processor is further configured to:
calculate a first impact of selecting the first radio change request on an efficiency of the wireless device;
calculate a second impact of selecting the second radio change request on an efficiency of the wireless device;
determine that the second impact is greater than the first impact; and
select the first radio change request based on the determination.

66. The communication apparatus of claim 63, wherein the wireless D2D communication connection comprises one or more of Long-Term Evolution Direct, AllJoyn, WiFi-Direct, WiFi Aware, Bluetooth, or Bluetooth Low Energy (BTLE).

67. The communication apparatus of claim 63, wherein the one or more transceivers are further configured to transmit new cross-device coexistence management data via the wireless D2D communication connection, the new cross-device coexistence management data including:
a new radio configuration report based on the changed one or more of the one or more radio parameters; and
a new radio change capability report based on the changed one or more of the one or more radio parameters.

68. A communication method for improving coexistence, comprising:
establishing, from a wireless device, a wireless device-to-device (D2D) communication connection with two or more discovered devices;
transmitting cross-device coexistence management data via the wireless D2D communication connection, the cross-device coexistence management data including a radio configuration report based on a configuration of one or more radio parameters of one or more radios associated with the wireless device; and
receiving, via the wireless D2D communication connection:
a first radio change request from a first wireless device of the two or more discovered devices; and
a second radio change request from a second wireless device of the two or more discovered devices;
selecting a preferred radio change request from among the first radio change request and the second radio change request;
changing one or more of the one or more radio parameters based on the preferred radio change request.

69. The communication method of claim 68, wherein the cross-device coexistence management data further includes a radio change capability report based on a radio change capability of the one or more parameters of the one or more radios associated with the wireless device.

70. The communication method of claim 68, wherein selecting the preferred radio change request comprises:
calculating a first impact of selecting the first radio change request on an efficiency of the wireless device;
calculating a second impact of selecting the second radio change request on an efficiency of the wireless device;
determining that the second impact is greater than the first impact; and
selecting the first radio change request based on the determination.

71. The communication method of claim 68, wherein the wireless D2D communication connection comprises one or more of Long-Term Evolution Direct, AllJoyn, WiFi-Direct, WiFi Aware, Bluetooth, or Bluetooth Low Energy (BTLE).

72. The communication method of claim 68, further comprising transmitting new cross-device coexistence management data via the wireless D2D communication connection, the new cross-device coexistence management data including:
a new radio configuration report based on the changed one or more of the one or more radio parameters; and
a new radio change capability report based on the changed one or more of the one or more radio parameters.
